(19) United States
(12) Patent Application Publication
(10) Pub. No.: US 2018/0188974 A1
(43) Pub. Date: Jul. 5, 2018

(54) COMPUTER PROGRAM PRODUCT, SYSTEM, AND METHOD TO ALLOW A HOST AND A STORAGE DEVICE TO COMMUNICATE USING DIFFERENT FABRIC, TRANSPORT, AND DIRECT MEMORY ACCESS PROTOCOLS

(71) Applicant: INTEL CORPORATION, Santa Clara, CA (US)

(72) Inventors: Phil C. CAYTON, Warren, OR (US); Jay E. STERNBERG, North Plains, OR (US); James P. FREYENSEE, Hillsboro, OR (US)

(21) Appl. No.: 15/630,884

(22) Filed: Jun. 22, 2017

Related U.S. Application Data
(63) Continuation-in-part of application No. 15/396,215, filed on Dec. 30, 2016.

(51) Int. Cl. G06F 3/06; G06F 15/173; G06F 13/42

(52) U.S. Cl. CPC G06F 3/0611; G06F 3/0688; G06F 2213/0026; G06F 15/17331; G06F 13/4282; G06F 3/0655

(57) ABSTRACT

Provided are a computer program product, system, and method to allow a host and a storage device to communicate using different fabric, transport, and direct memory access protocols. An origination package is received from an originating node at a first physical interface over a first network to a destination node having a storage device including a first fabric layer encoded according to a first fabric protocol, a first transport layer encoded according to a first transport protocol including a storage Input/Output (I/O) request directed to the storage device at the destination node. At least one destination packet is encoded with a second fabric layer and a second protocol layer according to the first fabric protocol or a second fabric protocol and according to the first transport protocol or a second transport protocol depending on what the destination node uses.

### TECHNICAL FIELD

Embodiments described herein generally relate to a computer program product, system, and method to allow a host and a storage device to communicate using different fabric, transport, and direct memory access protocols.

### BACKGROUND

Non-Volatile Memory Express (NVMe) is a logical device interface (http://www.nvmexpress.org) for accessing non-volatile storage media attached via a Peripheral Component Interconnect Express (PCIe) bus (http://www.pcsig.com). The non-volatile storage media may comprise a flash memory and solid solid-state drives (SSDs). NVMe is designed for accessing low latency storage devices in computer systems, including personal and enterprise computer systems, and is also deployed in data centers requiring scaling of thousands of low latency storage devices.

### BRIEF DESCRIPTION OF THE DRAWINGS

Embodiments are described by way of example, with reference to the accompanying drawings, which are not drawn to scale, in which like reference numerals refer to similar elements.

FIG. 1 illustrates an embodiment of a storage environment

FIG. 2 illustrates an embodiment of a target system.

FIG. 3 illustrates an embodiment of a storage device.

FIG. 4 illustrates an embodiment of a fabric packet.

FIG. 5 illustrates an embodiment of a virtual subsystem configuration.

FIGS. 6a and 6b illustrate an embodiment of operations to process fabric packets between host and target systems in different fabric networks.

FIG. 7 illustrates an embodiment of packet flow for a storage write request.

FIG. 8 illustrates an embodiment of packet flow for a storage read request.

FIG. 9 illustrates an embodiment of operations to process fabric packets between host and target systems in different fabric networks.

FIG. 10 illustrates an embodiment of operations to process a fabric packet when the origination node uses a direct memory access protocol and the destination node does not use a direct memory access protocol.

FIG. 11 illustrates an embodiment of operations to process a fabric packet when the origination node does not use a direct memory access protocol and the destination node uses a direct memory access protocol.

FIG. 12 illustrates an embodiment of packet flow for a storage write request according to FIG. 10.

FIG. 13 illustrates an embodiment of packet flow for a storage read request according to FIG. 10.

FIG. 14 illustrates an embodiment of packet flow for a storage write request according to FIG. 11.

FIG. 15 illustrates an embodiment of packet flow for a storage read request according to FIG. 11.

FIG. 16 illustrates an embodiment of packet flow for a storage read request according to FIG. 9.

FIG. 17 illustrates an embodiment of a computer node architecture in which components may be implemented

### DESCRIPTION OF EMBODIMENTS

A computer system may communicate read/write requests over a network to a target system managing access to multiple attached storage devices, such as SSDs. The computer system sending the NVMe request may wrap the NVMe read/write request in a network or bus protocol network packet, e.g., Peripheral Component Interconnect Express (PCIe), Remote Direct Memory Access (RDMA), Fibre Channel, etc., and transmit the network packet to a target system, which extracts the NVMe request from the network packet to process.

In NVMe environments, host nodes that communicate with target systems having different physical interfaces must include the physical interface used in each target system to which the host wants to connect.

A target system includes an NVMe subsystem with one or more controllers to manage read/write requests to namespace identifiers (NSID) defining ranges of addresses in the connected storage devices. The hosts may communicate to the NVMe subsystem over a fabric or network or a PCIe bus and port. An NVM subsystem includes one or more controllers, one or more namespaces, one or more PCIe ports, a non-volatile memory storage medium, and an interface between the controller and non-volatile memory storage medium.

Described embodiments provide improvements to computer technology to allow transmission of packets among different types of interfaces by providing a virtual target that allows host nodes and target systems using different physical interfaces and fabric protocols, and on different fabric networks, to communicate without the hosts and target systems having to have physical interfaces compatible with all the different fabric protocols being used. The virtual target system further provides a transfer memory to use to allow for direct memory access transfer of data between host nodes and target systems that are on different fabric networks using different fabric protocols and physical interfaces.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Certain embodiments relate to storage device electronic assemblies. Embodiments include both devices and methods for forming electronic assemblies.

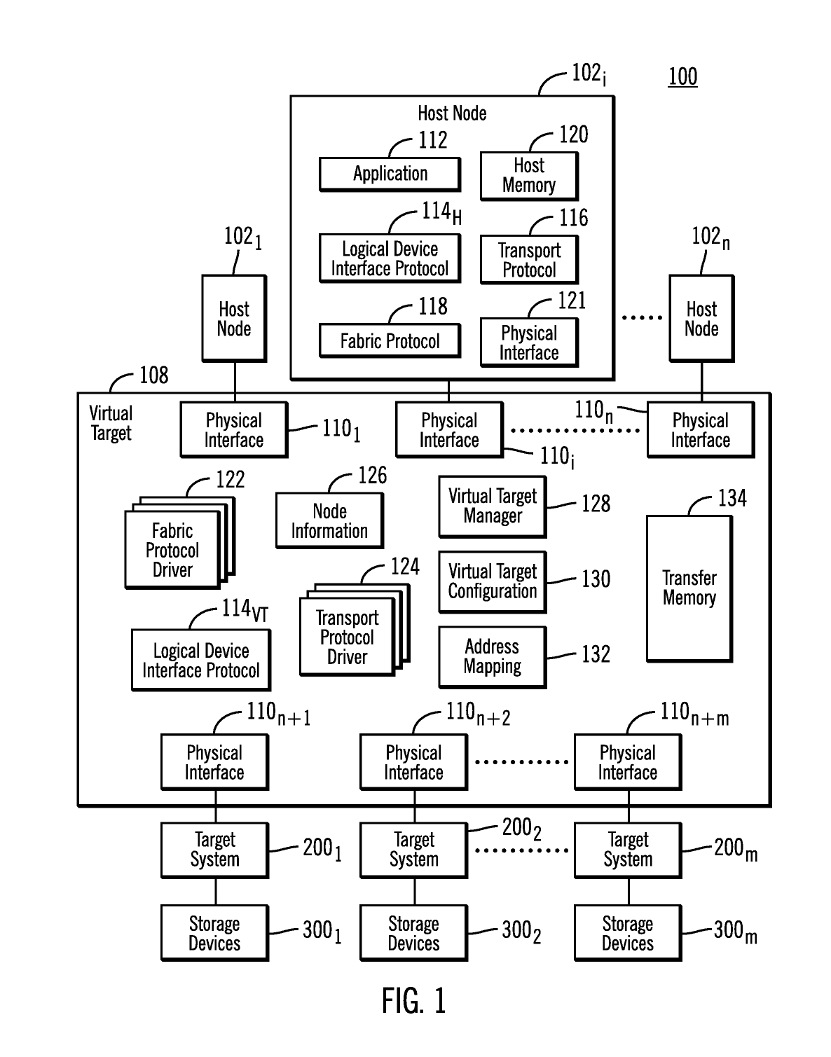

FIG. 1 illustrates an embodiment of a storage environment 100 having a plurality of host nodes 102₁ . . . 102ₙ that communicate with multiple storage devices 300₁ . . . 300ₘ via target systems 200₁ . . . 200ₘ. The host nodes 102₁ . . . 102ₙ may communicate with the target systems 200₁ . . . 200ₘ via a virtual target device 108 having physical interfaces 110₁, 110₂ . . . 110ₘ₊ₙ to physically connect to the host nodes 102₁ . . . 102ₙ and target systems 200₁ . . . 200ₘ, over different fabrics, such as Fibre Channel, internet Wide Area Remote Direct Memory Access (RDMA) Protocol (iWARP), InfiniBand, RDMA over Converged Ethernet (RoCE), Ethernet, etc.

Each of the host nodes 102₁ . . . 102ₙ, include, as shown with respect to host node 102ᵢ, an application 112 for generating I/O requests to the storage devices 300₁ . . . 300ₘ, a logical device interface protocol 114_{H}, such as Non-Volatile Memory Express (NVMe), to form a storage I/O request for the storage devices 300₁ . . . 300ₘ, a transport protocol 116, such as a direct memory access protocol (e.g., Remote Direct Memory Access (RDMA)), for transporting the storage I/O request, and a fabric protocol 118 to transport the request over the physical interface 110ₙ₊₁ . . . 110ₙ₊ₘ. The host node 102ᵢ further includes a host memory 120 for direct memory access operations with respect to memories in other devices and a physical interface 121 to connect to a corresponding physical interface 110ᵢ in the virtual target 108.

The virtual target 108 provides a bridge between host nodes 102₁ . . . 102ₙ and the target systems 200₁ . . . 200ₘ that communicate using different fabric protocols. The virtual target 108 maintains different fabric protocol drivers 122 to include fabric layers in packets to communicate over the different types of physical interfaces 110₁, 110₂ . . . 110ₘ₊ₙ. The virtual target 108 may also maintain different transport protocol drivers 124 to transport storage I/O requests for different transport protocols, e.g., Remote Direct Memory Access (RDMA), Transmission Control Protocol/Internet Protocol (TCP/IP), etc., and a logical device interface protocol 114_{VT} for processing the storage I/O requests.

The virtual target 108 further includes node information 126 providing the fabric protocol and transport protocol used by each of the nodes and host nodes 102₁ . . . 102ₙ and target systems 200₁ . . . 200ₘ in the storage environment 100; a virtual target manager 128 comprising the code to manage requests and communications between the host nodes 102₁ . . . 102ₙ and target systems 200₁ . . . 200ₘ; a virtual target configuration 130 providing a mapping of storage resources and namespaces in the storage devices 300₁ . . . 300ₘ, including any subsystems and controllers in the storage devices 300₁ . . . 300ₘ, and virtual storage resources that are presented to the host nodes 102₁ . . . 102ₙ; a transfer memory 134 used to buffer data transferred between the host memory 120 and the target systems 200₁ . . . 200ₘ; and an address mapping 132 that maps host memory 120 addresses to transfer memory 134 addresses. The host nodes 102₁ . . . 102ₙ direct storage I/O requests, in a logical device interface protocol, e.g., NVMe, to virtual storage resources. The virtual target manager 128 redirects the requests toward the physical storage resources managed by the target systems 200₁ . . . 200ₘ.

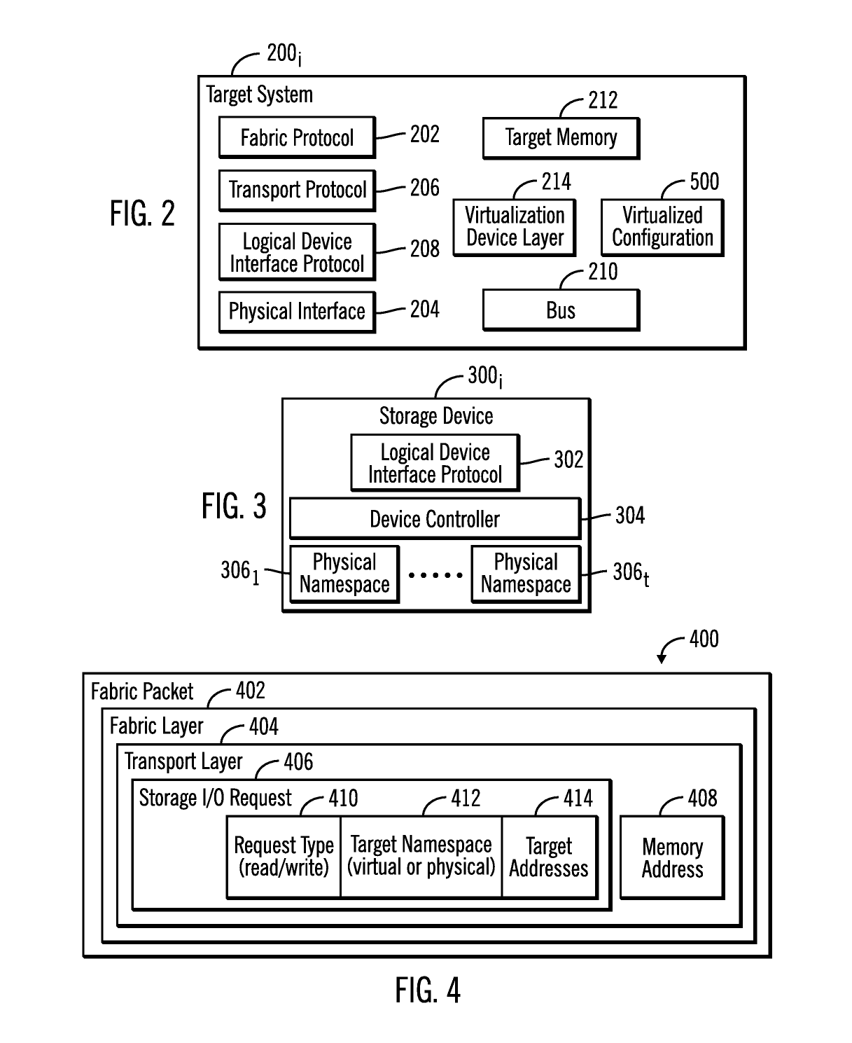

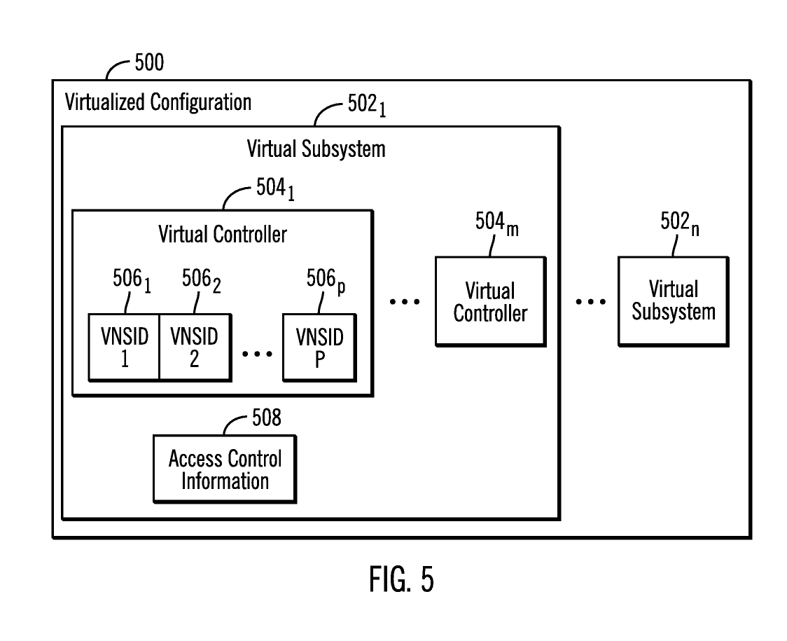

FIG. 2 shows the components in each target system 200ᵢ, such as target systems 200₁ . . . 200ₘ, as including a fabric protocol 202 to communicate through a physical interface 204 to a corresponding physical interface 110ⱼ on the target 108; a transport protocol 206, such as RDMA, to process the transport commands in a received packet through the physical interfaces 110₁, 110₂ . . . 110ₘ; a logical device interface protocol 208, such as NVMe, to process a storage request in a packet communicated from the virtual target 108 and to perform read/write operations with respect to the coupled storage devices 300i; a bus 210, such as Peripheral Component Interconnect Express (PCIe), to communicate logical device interface protocol (e.g., NVMe) read/write requests to the storage devices 300ᵢ; a target memory 212 to allow for direct memory access with the transfer memory 134; and a virtual device layer 214 that generates and manages a virtualized configuration 500 of virtualized storage subsystems that provide representations of target hardware and physical namespaces to the host nodes 102₁ . . . 102ₙ, including virtual subsystem definitions, virtual controller definitions, and virtualization namespace definitions. The virtualization device layer 214 or other virtual device layer may configure virtual subsystems, virtual controllers, and virtual namespaces in the target memory 212 to represent to the attached host nodes 102₁ . . . 102ₙ, such as described with respect to FIG. 5.

FIG. 3 illustrates components in each storage device 300ᵢ, such as storage devices 300₁ . . . 300ₘ, including a logical device interface protocol 302 (e.g., NVMe); a device controller 304 to perform storage device 300ᵢ operations, and one or more physical namespaces 306₁ . . . 306ₜ. A physical namespace comprises a quantity of non-volatile memory that may be formatted into logical blocks. When formatted, a namespace of size n is a collection of logical blocks with logical block addresses from 0 to (n−1). The namespaces may further be divided into partitions or ranges of addresses. The physical namespaces 306₁ . . . 306ₜ are identified by a namespace identifier (NSID) used by the device controller 304 to provide access to the namespace 306₁ . . . 306ₜ.

With described embodiments, a same NVMe read/write request capsule may be transmitted from the host nodes 102₁ . . . 102ₙ to the storage devices 300₁ . . . 300ₘ without the need for conversion or modification. Transmitting the same storage request capsule reduces latency in transmissions between the host nodes 102₁ . . . 102ₙ and the target systems 200₁ . . . 200ₘ using different type physical interfaces 110₁, 110₂ . . . 110ₘ₊ₙ and fabric protocols.

The host nodes 102₁ . . . 102ₙ may further comprise any type of compute node capable of accessing storage partitions and performing compute operations.

The program components of the 102₁ . . . 102ₙ, virtual target 108, target systems 200ᵢ, and storage devices 300ᵢ may be implemented in a software program executed by a processor of the target system 200, firmware, a hardware device, or in application specific integrated circuit (ASIC) devices, or some combination thereof.

The storage devices 300₁, 300₂ . . . 300ₘ may comprise electrically erasable and non-volatile memory cells, such as flash storage devices, solid state drives, etc. For instance, the storage devices 300₁, 300₂ . . . 300ₘ may comprise NAND dies of flash memory cells. In one embodiment, the NAND dies may comprise a multilevel cell (MLC) NAND flash memory that in each cell records two bit values, a lower bit value and an upper bit value. Alternatively, the NAND dies may comprise single level cell (SLC) memories, three bit per cell (TLC) or other number of bits per cell memories. The storage devices 300₁, 300₂ . . . 300ₘ may also comprise, but not limited to, ferroelectric random-access memory (FeTRAM), nanowire-based non-volatile memory, three-dimensional (3D) cross-point memory, phase change memory (PCM), memory that incorporates memristor technology, Magnetoresistive random-access memory (MRAM), Spin Transfer Torque (STT)-MRAM, a single level cell (SLC) Flash memory and other electrically erasable programmable read only memory (EEPROM) type devices. The storage devices 300₁, 300₂ . . . 300ₘ may also comprise a magnetic storage media, such as a hard disk drive etc.

The host memory 120, transfer memory 134, and target memory 212 may comprise a non-volatile or volatile memory type of device known in the art, such as a block addressable memory device, such as those based on NAND or NOR technologies. A memory device may also include future generation nonvolatile devices, such as a three dimensional crosspoint (3D crosspoint) memory device, or other byte addressable write-in-place nonvolatile memory devices. In some embodiments, 3D crosspoint memory may comprise a transistor-less stackable cross point architecture in which memory cells sit at the intersection of word lines and bit lines and are individually addressable and in which bit storage is based on a change in bulk resistance. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The memory device may refer to the die itself and/or to a packaged memory product. The memory device may further comprise electrically erasable programmable read only memory (EEPROM) type devices and magnetic storage media, such as a hard disk drive etc. In certain embodiments, the target system memory 136 comprises a persistent, non-volatile storage of the virtual subsystem, virtual controller, and virtual namespace definitions to provide persistent storage over power cycle events.

FIG. 4 illustrates an embodiment of a packet 400 for transmission across a network defined by physical interfaces 110₁, 110₂ . . . 110ₘ₊ₙ, and includes a fabric layer 402, including fabric information such as a header, error correction codes, source and destination addresses, and other information required for transmission through a specific physical interface type; a transport layer 404 providing commands and a format for transferring an underlying storage I/O request 406, such as a direct memory access protocol (e.g., RDMA), a packet based protocol, e.g., TCP/IP, etc. A direct memory access transport layer 404, in addition to including the storage I/O request 406, may also include a memory address 408, such as a host memory 120 address, transfer memory 134 address or target memory 212 address to allow for direct memory placement. The memory address 408 may comprise an advertised memory address and be in the form of a an RDMA memory key, byte offset and byte length in a memory region or memory window; a steering tag (STag), base address and length; or any other addressing method used to access a region of memory. The storage I/O request 406 may further include the data to transfer, not just the memory address 408 of the data, such as for in-packet data implementations.

In FIG. 4, the I/O request 406 may comprise a read or write request to a storage device 300ᵢ. The I/O request 406 may also comprise special type commands such as a flush command to cause the storage device 300ᵢ to flush writes in its internal cache to storage.

The term “packet” as used herein refers to a formatted unit of data carried by the different fabrics or networks. The term packet as used herein can refer to any formatted unit of data for any type of fabric or network that includes the different layers and control information, including any combination of different layers, such as a transport layer, network layer, data link layer, physical layer, etc., to transmit the storage I/O request 406.

The storage I/O request 406 may comprise a capsule of an encapsulated logic device interface protocol request, including a request type command 410, e.g., read or write; a target namespace 412, which may indicate a virtual namespace ID (VNSID) or physical namespace ID (NSID) to which the request 406 is directed; and specific target addresses 414 subject to the read/write request, which may comprise one or more logical block addresses in a storage device 300ᵢ which are subject to the requested read/write operation. The logic device interface protocol request 406 may include additional fields and information to process the request. Further, the storage I/O request 406 may comprise a response to a previous storage I/O request 406, such as a response to a read request or complete acknowledgment to a write request.

If the target system 200₁ . . . 200ₘ is sending a packet 400 to transfer I/O data for a storage I/O request 406 in a previously sent packet 400 from a host node 102₁ . . . 102ₙ, then the packet 400 sent by the target system 200ᵢ may not include the storage I/O request portion and just include an RDMA READ or WRITE command. When the previously sent packet 400 from the host node 102ᵢ includes a storage write request 406, then the packet 400 returned by the target system 200ᵢ may include an RDMA READ command to read the I/O data from the host node 102₁ . . . 102ₙ to retrieve the data subject to the previous storage write request 406 in order to write to the storage device 300ᵢ. When the previously sent packet 400 includes a storage read request 406 from the host node 102ᵢ, then the packet 400 returned by the target system 200ᵢ may include an RDMA WRITE command to write the requested I/O data from a storage device 300ᵢ to the host node 102₁ . . . 102ₙ.

FIG. 5 illustrates an embodiment of a virtualized configuration 500 providing a representation of a configuration of virtual subsystems 502₁ . . . 502ₙ in the target system 200, where each virtual subsystem 502₁ . . . 502ₙ may include, as shown with respect to virtual subsystem 502₁, one or more virtual controllers 504₁ . . . 504ₘ. Each virtual controller 504₁ . . . 504ₘ, as shown with respect to virtual controller 504₁, can include one or more assigned virtual namespace identifiers (VNSID) 506₁ . . . 506ₚ. Each virtual namespace identifier 506₁ . . . 506ₚ, maps to one or more physical namespaces 306₁ . . . 306ₜ in the storage devices 300₁ . . . 300ₘ, including a partition (range of addresses in the namespace) or the entire namespace. Each of the host nodes 102₁ . . . 102ₙ are assigned to one or more virtual subsystems 502₁ . . . 502ₙ, and further to one or more virtual namespace IDs 506₁ . . . 506ₚ in the virtual controllers 504₁ . . . 504ₘ of the virtual subsystems 502₁ . . . 502ₙ to which the host node 102ᵢ is assigned. The host nodes 102₁ . . . 102ₙ may access the physical namespace 306₁ . . . 306ₜ partitions that map to the virtual namespace IDs 506₁ . . . 506ₚ assigned to the hosts, where the host nodes 102₁ . . . 102ₙ access the virtual namespace through the virtual controller 504ᵢ to which the VNSID is assigned and virtual subsystem 502ᵢ to which the host node is assigned. The virtual subsystems 502ᵢ may include access control information 508 which indicates subsets of hosts allowed to access subsets of virtual controllers 504₁ . . . 504ₘ and namespaces (virtual or physical).

Different configurations of the virtual subsystems shown in FIG. 5 may be provided. For instance, the VNSIDs 506₁ and 506₂ in the virtual controller 504ᵢ may map to different partitions of a same physical namespace 120₁ in storage device 300₁, and/or one VNSID 506₃ in a virtual controller 504₂ may map to different physical namespaces 306₂ and 306₃ in storage device 300₂. In this way, a write to the VNSID 400₃ in the second virtual controller 300₂ writes to two separate physical namespaces 306₂, 306₃.

Additional configurations are possible. For instance, the same defined virtual namespace identifier that maps to one physical namespace may be included in two separate virtual controllers to allow for the sharing of a virtual namespace and the mapped physical namespace. Further, one virtual namespace can map to different physical namespaces or different partitions within a namespace in the same or different storage devices. A virtual namespace mapping to a physical namespace/partition may be included in multiple virtual controllers 504ᵢ of one virtual subsystem to allow sharing of the virtual namespace by multiple hosts.

The virtual target 108 maintains a local copy of the virtual target configuration 130 for the virtualized configuration 600 in every connected target systems 200₁ . . . 200ₘ.

The host nodes 102₁ . . . 102ₙ may address a virtual namespace, by including the virtual subsystem (VSS) name, the virtual controller (VC), and the virtual namespace identifier (VNSID) in a combined address, such as VSSname. VCname. VNSID. In this way, virtual namespace IDs in different virtual controllers may have the same number identifier but point to different physical namespaces/partitions. Alternatively, the same virtual namespace IDs in different virtual controllers may point to the same shared physical namespace/partition. The virtual target 108 may then map the requested virtual resources to the target system 200ᵢ providing those virtualized resources and mapping to the corresponding physical resources.

FIG. 5 shows implementations of virtual subsystems and controllers. In further embodiments, some or all of the subsystems and controllers may be implemented in physical hardware components and not virtualized. In such physical implementations, the controllers may be assigned physical namespaces 306₁ . . . 306ₜ may address a namespace using the physical namespace 306₁ . . . 306ₜ addresses.

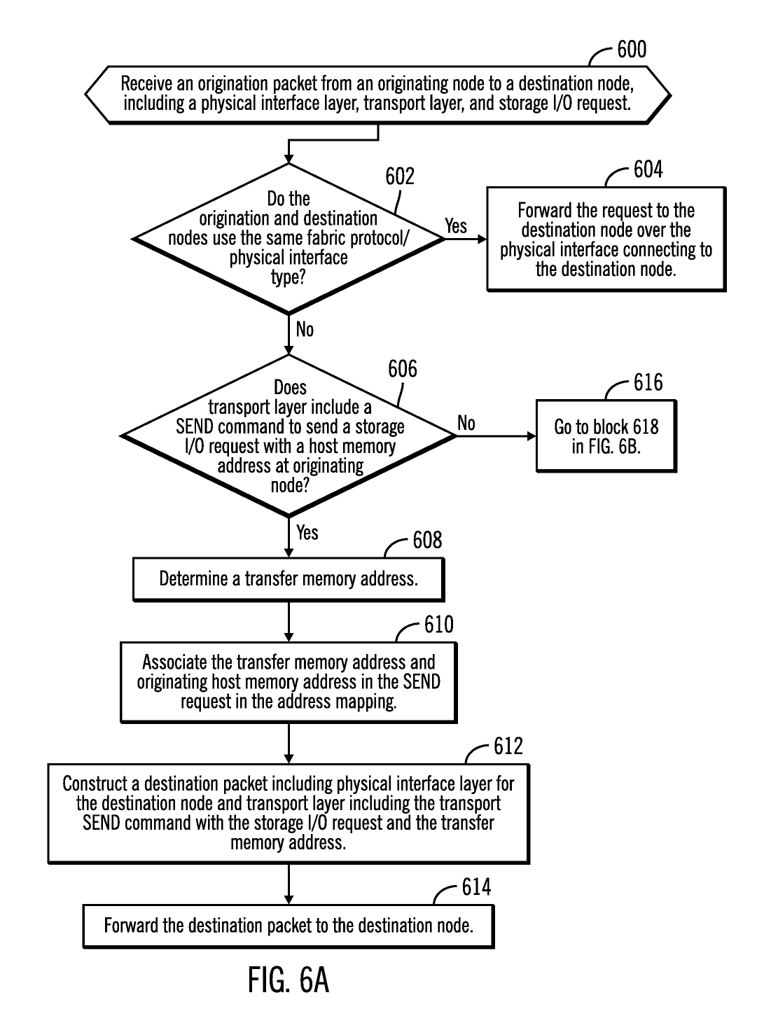

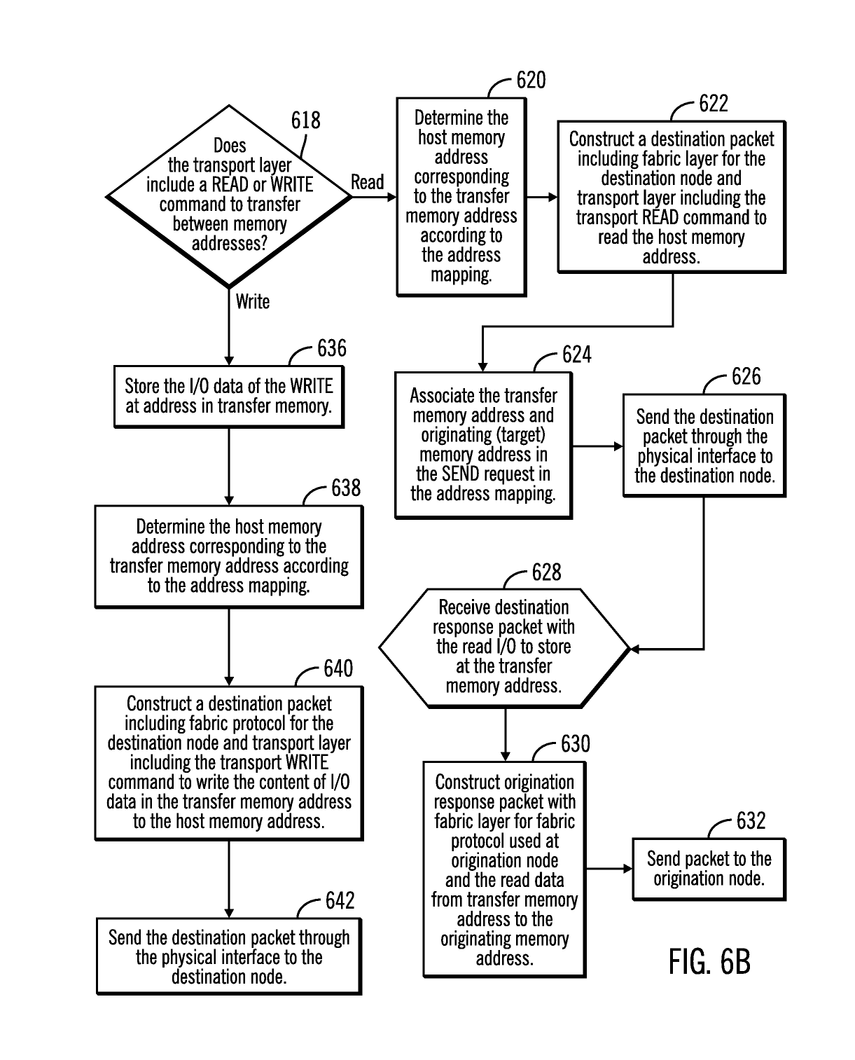

FIGS. 6a and 6b illustrate an embodiment of operations performed by the virtual target manager 128 to process a packet 400_{O} from an originating node to a destination node, such as a request comprising a packet 400_{O} with a fabric layer, 402, transport layer 404, and storage I/O request 406 from a host node 102ᵢ. The origination node may comprise a host node 102₁ . . . 102ₙ transmitting a request to a target system 200₁ . . . 200ₘ with a storage read/write request 406 or a target system 200₁ . . . 200ₘ transmitting a command to transfer I/O data for the storage I/O request 406 in the previous packet. The destination node may comprise the target system 200₁ . . . 200ₘ sending I/O data to the storage I/O request 406 or a host node 102₁ . . . 102ₙ receiving the I/O data from the target system 200₁ . . . 200ₘ. Upon the virtual target 108 receiving (at block 600) an origination packet 400_{O} from an origination node, the virtual target manager 128 determines (at block 602) from the node information 126 whether the origination and destination nodes use the same physical interface type/fabric protocol. If so, then the packet 400_{O} is forwarded (at block 604) to the destination node unchanged.

If (at block 602) the origination and destination nodes use different fabric protocols to communicate on different fabric networks, then a determination is made (at block 606) as to whether the transport layer 404 includes a SEND command, such as an RDMA SEND command, to send a storage I/O request 406 with a host memory address 408 at the originating host node 102₁ . . . 102ₙ. In alternative embodiments, the transport layer 404 may utilize different transport protocols other than RDMA. The virtual target manager 128 determines (at block 608) a transfer memory 134 address to use for the I/O data being transferred via direct memory access between memory addresses as part of the storage I/O request 406. The determined transfer memory 134 address is associated (at block 610) in the address mapping 132 with the originating host memory address 408 in the SEND request in the transport layer 404.

The virtual target manager 128 constructs (at block 612) a destination packet 400_{D} including a fabric layer 402 for the destination node, which uses a different fabric protocol than the fabric layer 402 used in the origination packet 400_{O}, and transport layer 404 including the transport SEND command with the storage I/O request 406 capsule and the transfer memory 134 address as the memory address 408, to substitute the transfer memory 134 address for the host memory 120 address included in the origination packet 400_{O}. The destination packet 400_{D} is forwarded (at block 614) to the destination node via the physical interface physical interface 110ₙ₊₁, 110ₙ₊₂ . . . 110ₘ₊ₙ of the destination node.

If (at block 606) the transport layer 404 does not include a SEND command, then control proceeds (at block 616) to block 618 in FIG. 6b. At block 618, the virtual target manager 128 determines whether the transport layer 404 includes a READ or WRITE command, which would be sent by a target system 200₁ . . . 200ₘ as a response to a storage I/O request 406 in the origination packet 400_{O}. If (at block 618) the transport layer 404 includes a READ request, such as an RDMA READ, to access the data to write to the storage device 300ᵢ, then the virtual target manager 128 determines (at block 620) the host memory 120 address corresponding to the transfer memory 134 address according to the address mapping 132. A destination packet 400_{D} is constructed (at block 622) including the fabric layer 402 for the destination node (e.g., target system 200₁ . . . 200ₘ) and a transport layer 404 including the transport READ command to read the host memory 120 address, which may be indicated in the memory address field 408. The destination packet 400_{D} may not include a storage I/O request layer 406 layer because the destination packet 400_{D} is being used to transmit the I/O data for the previously sent storage I/O request 406. The transfer memory 134 address and the target memory 212 address may be associated (at block 624) in the address mapping 132. The destination packet 400_{D} is sent (at block 626) through a host physical interface 110₁, 110₂ . . . 110ₙ to the host node 102ᵢ that initiated the storage I/O request 406. In this way, the host memory 120 address is substituted for the transfer memory 134 address in the received packet.

Upon receiving (at block 628) at the virtual target 108 a destination response packet 400_{DR} to the READ command in the transport layer 404 of the destination packet 400_{D} with the read I/O data to store at the transfer memory 134 address, the virtual target manager 128 constructs (at block 630) an origination response packet 400_{OR} with the origination node fabric protocol and the read I/O data from the transfer memory 134 address to the originating (target) memory 212 address. The constructed packet 400 with the read I/O data, being returned for a storage write request 406, is sent (at block 632) to the origination node, which may comprise the target systems 200ᵢ to store the read data in the target address 414 of the storage write request 406 in a storage device 300ᵢ.

If (at block 618) the transport layer 404 of the origination packet 404_{O} includes a WRITE request, such as an RDMA WRITE, to return the data requested in the storage I/O request 406 at the target address 414 of the storage device 300ᵢ, then the virtual target manager 128 stores (at block 636) the I/O data of the RDMA WRITE request in an address in the transfer memory 134, which would comprise the memory address 408 included in the destination packet 400_{D} constructed at block 612. The virtual target manager 128 determines (at block 638) the host memory 120 address corresponding to the transfer memory 134 according to the address mapping 132. A destination packet 400_{D} is constructed (at block 640) including fabric protocol in the fabric layer 402 for the destination node and a transport layer including the transport WRITE command to write the content of the I/O data in the transfer memory 134 address to the host memory 120 address. The destination packet 400_{D} is sent (at block 642) through the physical interfaces 110ᵢ to the destination node, which may be host node 102ᵢ originating the packet 400 with the storage I/O request 406.

With the described embodiments of FIGS. 6a and 6b, the virtual target manager 128 allows for transmission of packets between different fabric types, such as different networks, by constructing a new packet using the fabric layer protocol of the destination node and using the transfer memory in the virtual target 108 to buffer data being transferred between the origination and destination nodes. Further, with the described embodiments, when transmitting a SEND command in the transport layer, the capsule including the storage I/O request 406 is not modified and passed unchanged through the different packets constructed to allow transmission through different fabric layer types having different physical interface configurations.

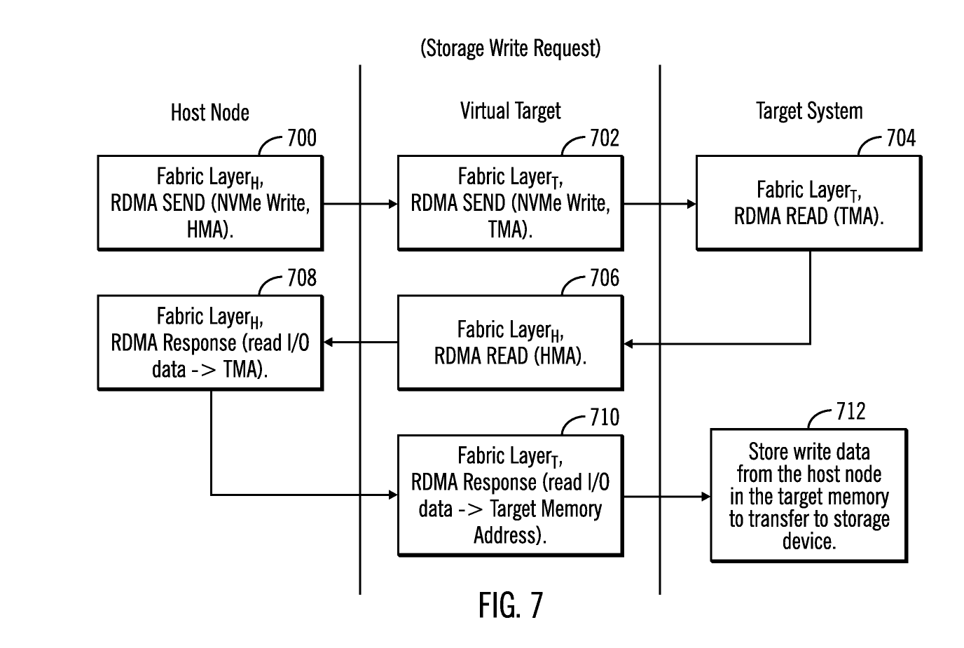

FIG. 7 illustrates an embodiment of the flow of a write request through a virtual target 108, wherein the host node 102ᵢ initiates operations by generating a packet 700 including a Fabric Layer 402_{H} of the host node 102ᵢ with an RDMA send command including a capsule 406 having an NVMe write to a target address 414 with a host memory 120 address (HMA) having the write data for the NVMe write request. Upon receiving this packet 700, the virtual target 108 generates a packet 702 including a Fabric Layer 402_{T} for the target system 200ᵢ managing the storage device 300ᵢ to which the NVMe write 406 is directed and a transfer memory 134 address (TMA) associated with the host memory 120 address (HMA). Upon the target system 200ᵢ receiving the packet 702, the target system 200ᵢ constructs a packet 704 including the Fabric Layer 402_{T} for the target system 200ᵢ and an RDMA read to the transfer memory 134 address (TMA) to read the data of the NVMe write 406 from the host memory 120 to store in the storage device 300ᵢ. Upon the virtual target 108 receiving packet 704, a packet 706 is constructed having the host Fabric Layer 402_{H} and an RDMA read to the host memory 120 address (HMA) mapping to the transfer memory 134 address (TMA) in the packet 704.

When the host receives the packet 706 with the RDMA read request in the transport layer 404, the host 102ᵢ constructs a packet 708 having the host Fabric Layer 402_{H} and an RDMA response in the transport layer 404 including the read I/O data to write and the transfer memory 134 address (TMA) to place the data. The virtual target 108 upon receiving packet 708 with the returned I/O data, constructs a packet 710 having the target system Fabric Layer 402_{T} with the response to the read with the read I/O data to send to the target memory 212 address. Upon receiving the packet 710, the target system 200ᵢ stores (at block 712) the I/O data from the host node 102ᵢ for the original write request in the target memory 212 for transfer to the storage device 300ᵢ to complete the initial write request.

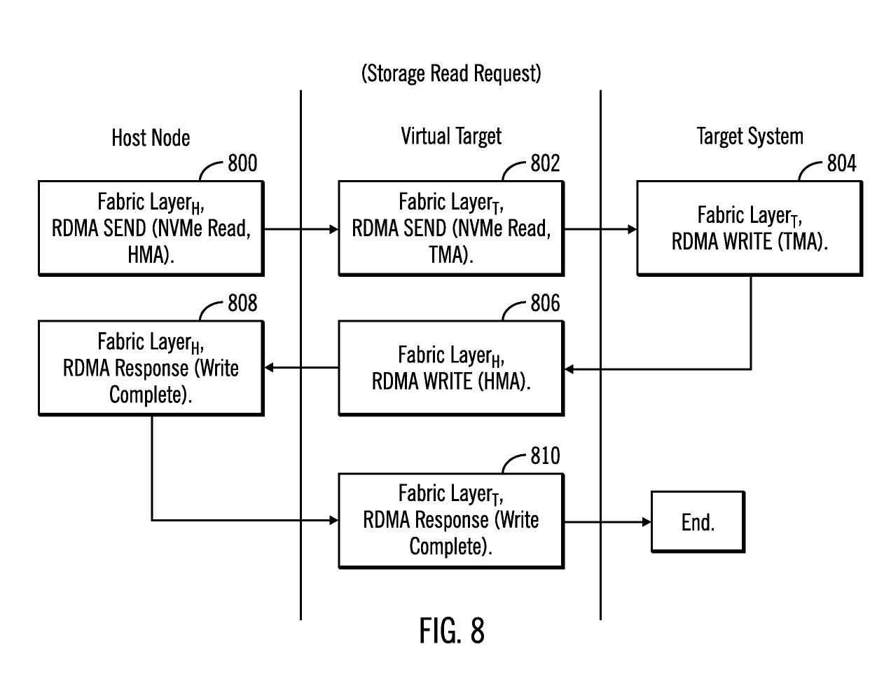

FIG. 8 illustrates an example of the flow of a read request through a virtual target 108, wherein the host node 102ᵢ initiates operations by generating a packet 800 including a Fabric Layer 402_{H} of the host node 102ᵢ with an RDMA SEND command including a capsule 406 having an NVMe read to a target address 414 with a host memory 120 address (HMA) to which to return the I/O data for the NVMe read request. Upon receiving this packet 800, the virtual target 108 generates a packet 802 including a Fabric Layer 402_{T} for the target system 200ᵢ managing the storage device 300ᵢ to which the NVMe read 406 is directed and a transfer memory 134 address (TMA) associated with the host memory 120 address (HMA). Upon the target system 200ᵢ receiving the packet 802, the target system 200ᵢ constructs a packet 804 including the Fabric Layer 402_{T} for the target system 200ᵢ and an RDMA write to the transfer memory 134 address (TMA) to return the data read for the NVMe read 406 to the host node 102ᵢ. Upon the virtual target 108 receiving packet 804, a packet 806 is constructed having the host Fabric Layer 402_{H} and an RDMA write in the transport layer 404 to the host memory 120 address (HMA) mapping to the transfer memory 134 address (TMA) in the packet 804.

When the host 102ᵢ receives the packet 806 with the RDMA write and I/O data in the transport layer 404, the host 102ᵢ accepts the read I/O data and constructs a response packet 708 having the host Fabric Layer 402_{H} and an RDMA response in the transport layer 404 indicating that the RDMA write to transfer the read I/O data completed. The virtual target 108 upon receiving response packet 808 with the complete response for the RDMA write, constructs a packet 810 having the target system Fabric Layer 402_{T} with the complete response to the RDMA read. Upon receiving the packet 810, the target system 200ᵢ ends processing of the RDMA write.

With the described packet flow of FIGS. 7 and 8, packets are allowed to be sent through different fabrics by having an intermediary virtual target that has different physical interfaces 110₁, 110₂ . . . 110ₘ₊ₙ for different fabric network types. The virtual target 108 may receive a packet on one fabric network and construct a packet to forward to a destination node in a different fabric network. The virtual target may use a transfer memory to allow direct memory data placement between the memories of the host node and target system on different fabric networks using different fabric protocols and physical interface types. Further, latency is reduced by transporting the capsule NVMe request unchanged through the different packets and networks.

The flow of FIGS. 7 and 8 were described using RDMA as the transport layer protocol and NVMe as the logical storage interface protocol. In alternative embodiments, different protocols may be used for the transport layer and storage layer with the storage I/O request. For instance, in one implementation, the host node 102ᵢ and target system 200ᵢ may communicate using different variants of the RDMA transport layer, such as iWARP and InfiniBand. In a still further embodiment, the host node 102ᵢ and target system 200ᵢ may communicate using entirely different protocols, such as RDMA versus Fibre Channel. Other variants that may be similar or different may also be used by the host nodes and target systems.

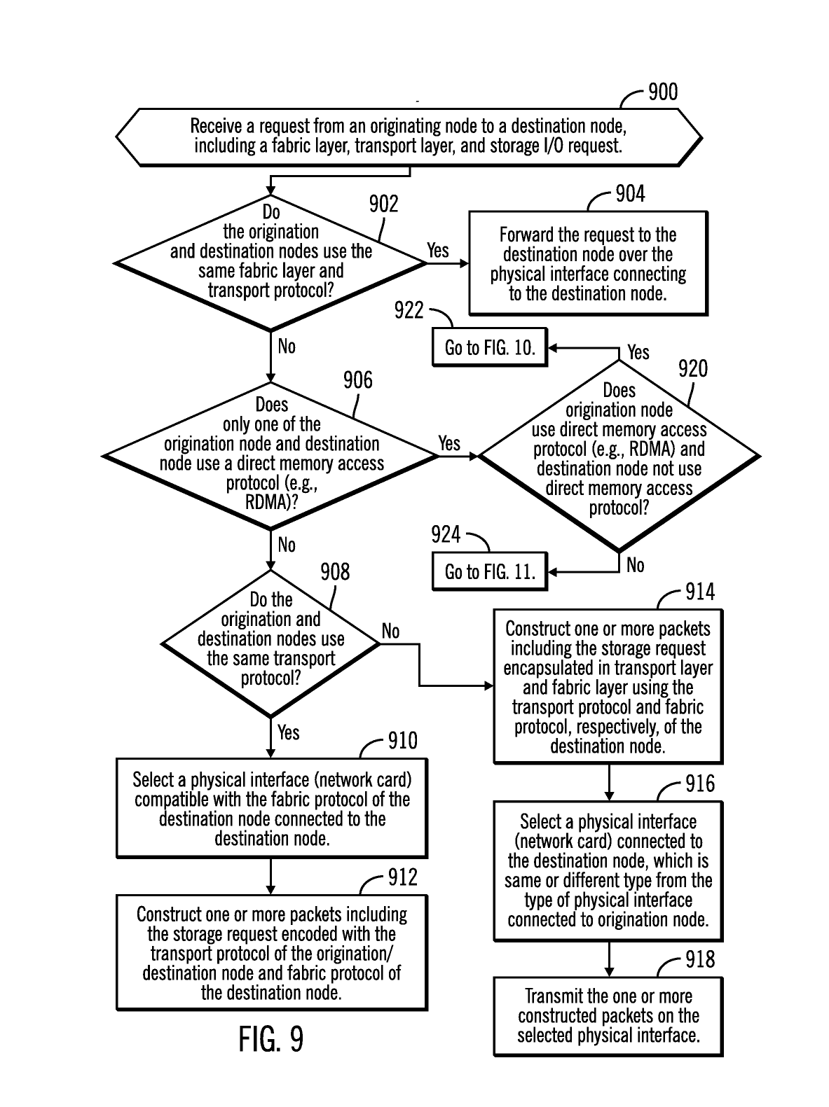

FIG. 9 illustrates an embodiment of operations performed by the virtual target manager 128 to process a packet 400 from an originating node 102ᵢ to a destination node 200ᵢ, such as a request comprising a packet 400_{O} with a fabric layer, 402, transport layer 404, and storage I/O request 406 from a host node 102ᵢ. The origination node may comprise a host node 102₁ . . . 102ₙ transmitting a request to a destination node comprising a target system 200₁ . . . 200ₘ with a storage read/write request 406. The destination node may comprise the target system 200₁ . . . 200ₘ sending I/O data to the storage I/O request 406. Upon the virtual target 108 receiving (at block 900) an origination packet 400_{O} from an origination node, the virtual target manager 128 determines (at block 902) from the node information 126 whether the origination and destination nodes use the same physical interface type/fabric protocol and transport protocol. If so, then the packet 400_{O} is forwarded (at block 904) to the destination node 200ᵢ unchanged.

If (at block 902) the origination and destination nodes use different fabric protocols to communicate on different fabric networks or different transport protocols for the transport layer 404, then a determination is made (at block 906) as to whether only one of the origination node 102ᵢ and destination node 200ᵢ use a direct memory access protocol (e.g., RDMA). If either both nodes use RDMA or neither does, then if (at block 908) the origination and destination nodes use the same transport protocol, then the virtual target manager 128 selects (at block 910) a physical interface 110ₙ₊₁ . . . 110ₙ₊ₘ (network card) compatible with the fabric layer of the destination node 200ᵢ. The virtual target manager 128 constructs (at block 912) one or more packets including the storage request 406 encoded with the transport protocol of the origination and destination nodes and fabric layer of the destination node. If (at block 908) the origination and destination nodes do not use the same transport protocol for their transport layer, then the virtual target manager 128 constructs (at block 914) one or more packets including the storage request encapsulated in a transport layer 404 and fabric layer 402 using the transport protocol and fabric protocol, respectively, of the destination node 200ᵢ. The virtual target manager 128 selects (at block 916) a physical interface (network card) 110ₙ₊₁ . . . 110ₙ₊ₘ connected to the destination node 200ᵢ, which is same or different type from the type of physical interface 110₁ . . . 110ₙ connected to origination node. The one or more constructed packets 400 (at block 918) are transmitted on the selected physical interface 110ₙ₊₁ . . . 110ₙ₊ₘ.

If both of the origination and destination nodes use a direct memory access protocol (RDMA), then in addition to selecting the transport and fabric protocols to use according to blocks 908-918, the virtual target manager 128 may further perform the operations with respect to FIGS. 6a, 6b, 7, and 8.

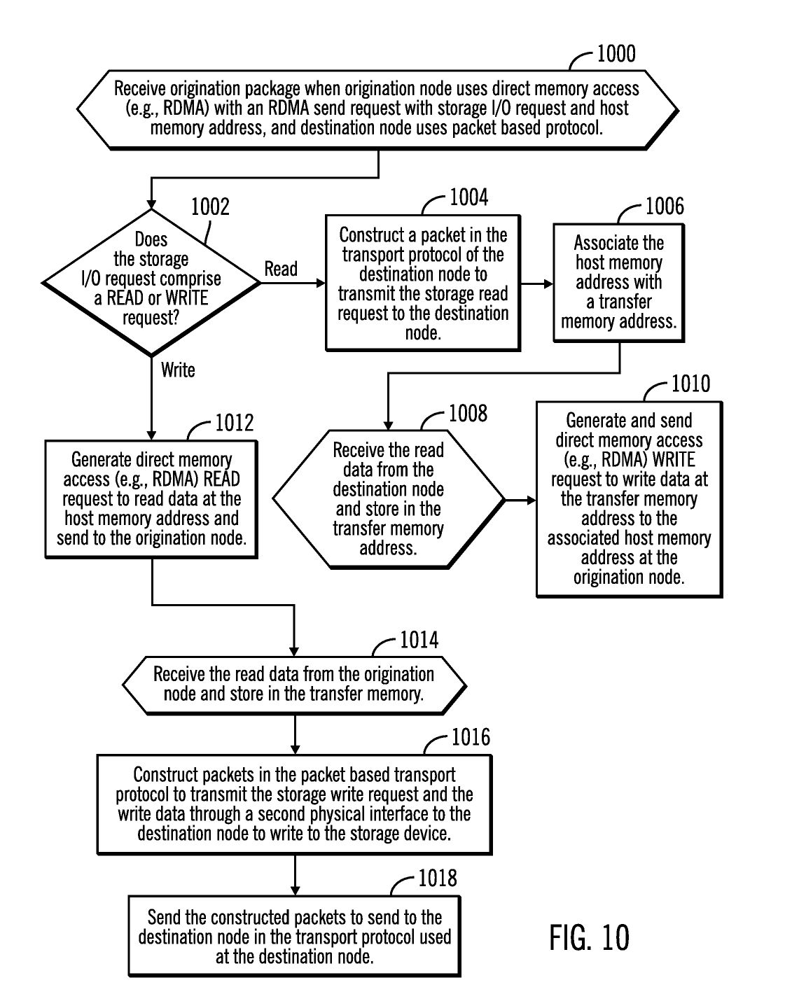

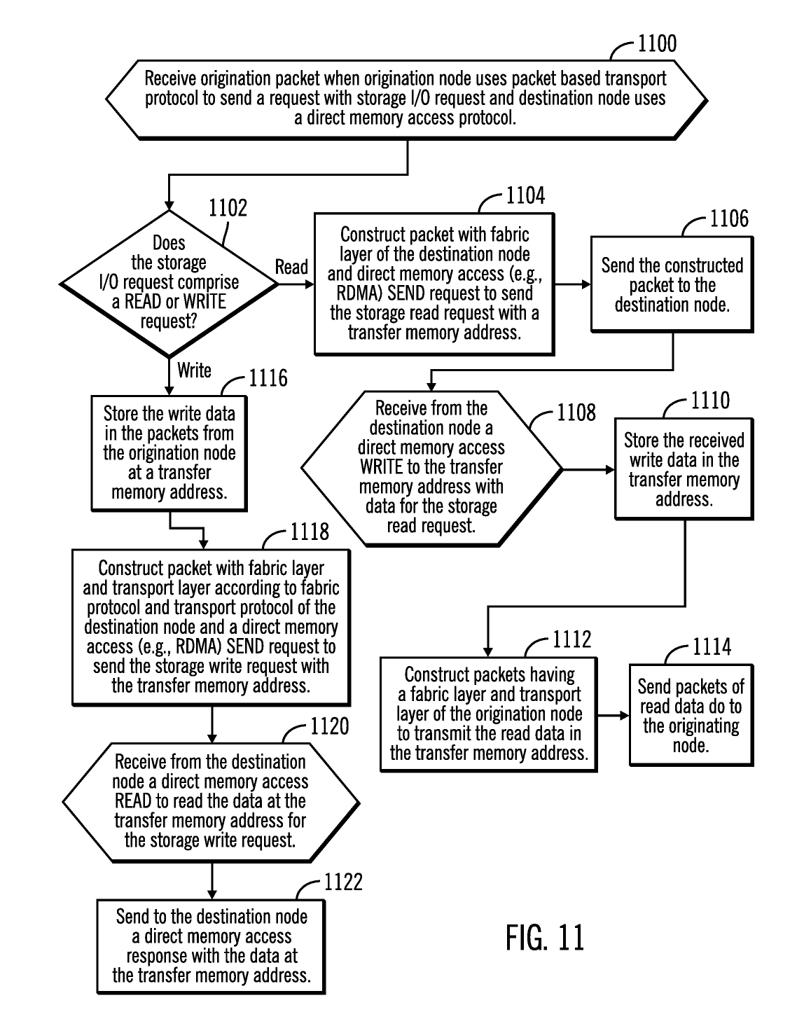

If (at block 906) only one of the origination and destination nodes use a direct memory access protocol, (e.g., RDMA), then if (at block 920) the origination node uses a direct memory access protocol and the destination node does not use, then control proceeds (at block 922) to FIG. 10. Otherwise, if (at block 920) the destination node uses a direct memory access protocol and the origination node does not use, then control proceeds (at block 924) to FIG. 11.

In one embodiment, the logical device interface protocol may comprise a Non-Volatile Memory Express (NVMe) protocol, the transport protocol may comprise one of Transport Control Protocol/Internet Protocol (TCP/IP), User Datagram Protocol (UDP), and Remote Direct Memory Access (RDMA) over Converged Ethernet (RoCE) when RDMA is used, and the fabric layer protocol may comprise one of Ethernet, InfiniBand, Fibre Channel, and iWARP when RDMA is used.

FIG. 10 illustrates an embodiment of operations performed by the virtual target manager 128 upon receiving (at block 1000) an origination package with a direct memory access protocol (e.g., RDMA) send request, from an origination node 102ᵢ that uses a direct memory access protocol (e.g., RDMA), where the RDMA send request includes storage I/O request and host memory address in the host memory 120, and where the destination node uses a packet based protocol. If (at block 1002) the storage I/O request comprises a read request, then the virtual target manager 128 constructs (at block 1004) a packet 400 having a fabric layer 402 and transport layer 404 in the fabric and transport protocols, respectively, of the destination node 200ᵢ to transmit the storage read request to the destination node. The host memory address 408 provided in the origination package 400_{O} is associated (at block 1006) with a transfer memory address in the transfer memory 134 in the address mapping 132. The virtual target 108 receives (at block 1008) the read data from the destination node 200ᵢ and stores in the transfer memory address in the transfer memory 134. The virtual target manager 128 generates and sends (at block 1010) a direct memory access (e.g., RDMA) WRITE request to write data at the transfer memory address to the associated host memory address at the origination node 102ᵢ to complete the read.

If (at block 1002) the storage I/O request comprises a write request, then the virtual target manager 128 generates (at block 1012) a direct memory access (e.g., RDMA) READ request to read data from the origination node 102ᵢ at the host memory address and sends back to the origination node 102ᵢ. This RDMA read request may be encapsulated in a packet 400 having a fabric layer 402 and transport layer 404 in the fabric and transport protocols, respectively, used at the origination node 102ᵢ. In response to the RDMA read request to the origination node 102ᵢ, the virtual target manager 128 receives (at block 1014) the read data from the origination 102ᵢ node and stores in the transfer memory 134. The virtual target manager 128 constructs (at block 1016) one or more packets in the packet based protocol of the destination mode 200ᵢ to transmit the storage write request and the write data, read at block 1012, through a second physical interface 110ₙ₊₁ . . . 110ₙ₊ₘ to the destination node 200ᵢ to write to the storage device 300ᵢ. The constructed one or more packets are sent to the destination node 200ᵢ in the transport protocol of the destination node 200ᵢ.

FIG. 11 illustrates an embodiment of operations performed by the virtual target manager 128 upon receiving (at block 1100) an origination package 400_{O} from an origination node 102ᵢ that uses a packet based protocol to send a storage I/O request 406 and does not use a direct memory access protocol (e.g., RDMA). The storage I/O request 406 is directed to a destination node 200ᵢ that uses a direct memory access protocol (e.g., RDMA). If (at block 1102) the storage I/O request comprises a read request, then the virtual target manager 128 constructs (at block 1104) a packet 400 having a transport layer 404 in the transport protocol of the destination node and fabric layer 402 in the fabric protocol of the destination node including a direct memory access (e.g., RDMA) send request to send the storage read request to the destination node 200ᵢ with a transfer memory address in the transfer memory 134 to use to buffer the read data. The constructed packet is sent (at block 1106) to the destination node 200ᵢ. The virtual target 108 receives (at block 1108) from the destination node a direct memory access (e.g., RDMA), write to the transfer memory address 408 with the data for the storage read request. The received data is stored (a block 1110) in the transfer memory 134 address. The virtual target manager 128 constructs (at block 1112) packets having a fabric layer 402 and transport layer 404, such as a packet based transport protocol, used at the origination node 102ᵢ to transmit the read data for the storage read request in the transfer memory address. The packets of the read data are sent (at block 1114) to the originating node 102ᵢ.

If (at block 1102) the storage I/O request 406 comprises a write request, then the virtual target manager 128 stores (at block 1116) the write data in the packets from the origination node 200ᵢ to write in a transfer memory address. The virtual memory manager 128 constructs (at block 1118) a packet with the fabric layer 402 and transport layer 404 according to fabric protocol and transport protocol of the destination node 200ᵢ and a direct memory access (e.g., RDMA) SEND request to send the storage write request with the transfer memory address 408. In response to the SEND request, the virtual target manager 128 receives (at block 1120) from the destination node 200ᵢ a direct memory access READ to read data at the transfer memory address for the storage write request. The virtual target manager 128 sends (at block 1122) to the destination node 300ᵢ a direct memory access response with the data at the transfer memory address to return to the read request, and write the data from the initial storage write request.

The described embodiments of FIGS. 9, 10, and 11 allow the transmission of a storage read/write request from an origination node to a destination node when the origination destination nodes use or do not use a direct memory access protocol, and when they use the same or different fabric and transport protocols.

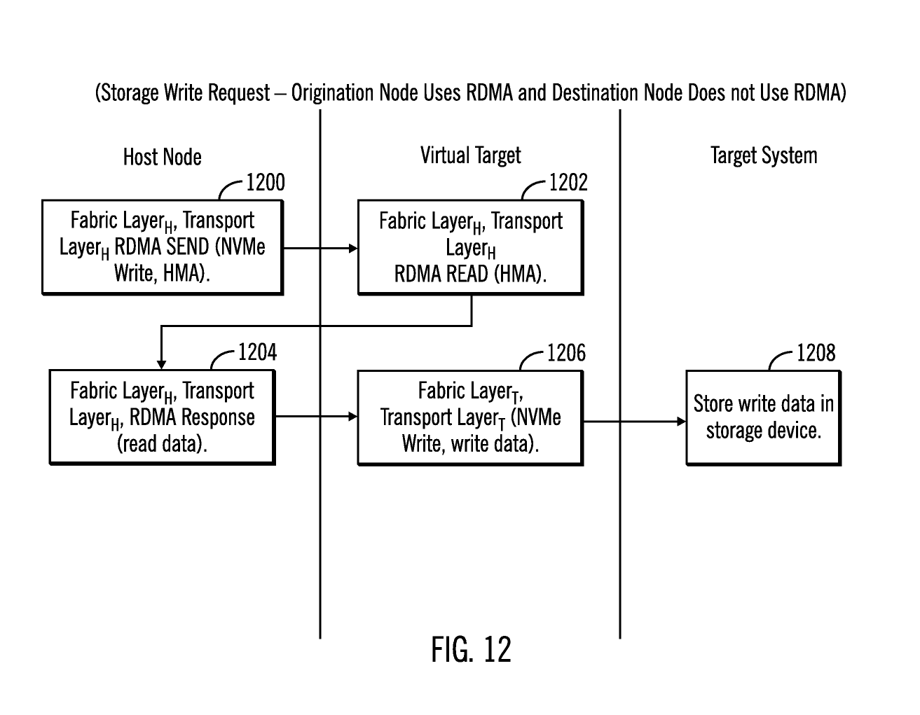

FIG. 12 illustrates an example of the flow of a write request through a virtual target 108 when the origination node 102ᵢ uses a direct memory access protocol and the destination node 200ᵢ does not use a direct memory access protocol according to the operations of FIG. 10. A host node 102ᵢ initiates operations by generating a packet 1200 including a fabric layer 402_{H} and transport layer 406_{H} of the host node 102ᵢ with an RDMA send command including a capsule 406 having an NVMe write to a target address 414 with a host memory 120 address (HMA) having the write data for the NVMe write request. Upon receiving this packet 1200, the virtual target 108 generates a packet 1202 including a fabric layer 402_{H} and transport layer 404_{H} for the origination system 1020ᵢ with an RDMA read of the data at the host memory address. The host node 102ᵢ in response to the RDMA read constructs one or more packets 1204 in the fabric 402_{H} and transport 404_{T} layers of the host node 102ᵢ including the read data from the host memory address. The virtual target server 128 constructs one or more packets 1206 in the fabric layer 402_{T} and transport layer 404_{T} according to the fabric protocol and transport protocol of the target node 200ᵢ, including the NVMe write 406 and the write data, comprising the read data returned in packets 1204. The write data is stored at block 1208 in the storage device 300ᵢ.

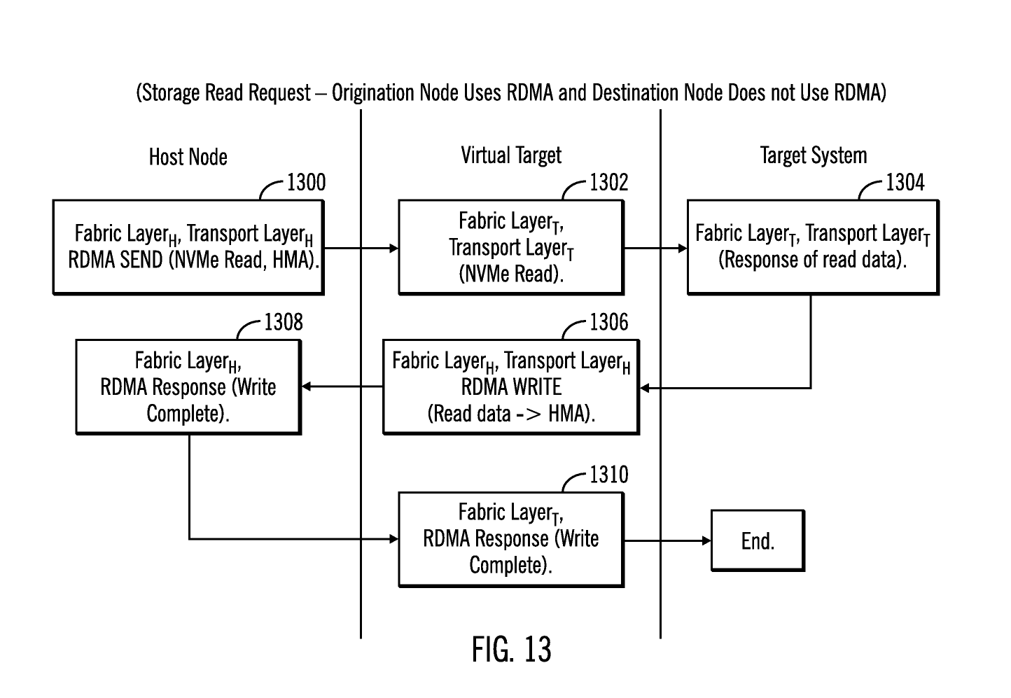

FIG. 13 illustrates an example of the flow of a read request through a virtual target 108 when the origination node 200ᵢ uses a direct memory access protocol and the destination node 200ᵢ does not use a direct memory access protocol according to the operations of FIG. 10. The host node 102ᵢ initiates operations by generating a packet 1300 including a fabric 402_{H} and transport 404_{H} layers of the host 102ᵢ with an RDMA SEND command including a capsule 406 having an NVMe read to a target address 414 with a host memory 120 address (HMA) to which to return the read data for the NVMe read request. Upon receiving this packet 1300, the virtual target 108 generates a packet 1302 including a fabric layer 402_{T} and transport layer 404_{T} for the target (destination) system 200ᵢ managing the storage device 300ᵢ to which the NVMe read 406 is directed. Upon the target system 200ᵢ receiving the packet 1302, the target system 200ᵢ constructs a packet 1304 including the fabric layer 402_{T} and transport layer 404 for the target system 200ᵢ with the response having the read data. Upon the virtual target 128 receiving packet 1304, a packet 1306 is constructed having the host fabric layer 402_{H} and transport layer 404_{H}, and an RDMA write having the read data to store in the host memory 120 address.

When the host 102ᵢ receives the packet 1306 with the RDMA write and write data, the host 102ᵢ accepts the read I/O data and constructs a response packet 1308 having the host fabric layer 402_{H} and transport layer 404_{H}, and an RDMA response indicating that the RDMA write to transfer the read I/O data completed. The virtual target 108 upon receiving response packet 1308 with the complete response for the RDMA write, constructs a packet 1310 having the target system fabric layer 402_{T} with the complete response to the RDMA read. Upon receiving the packet 1310, the target (destination) system 200ᵢ ends processing of the RDMA write.

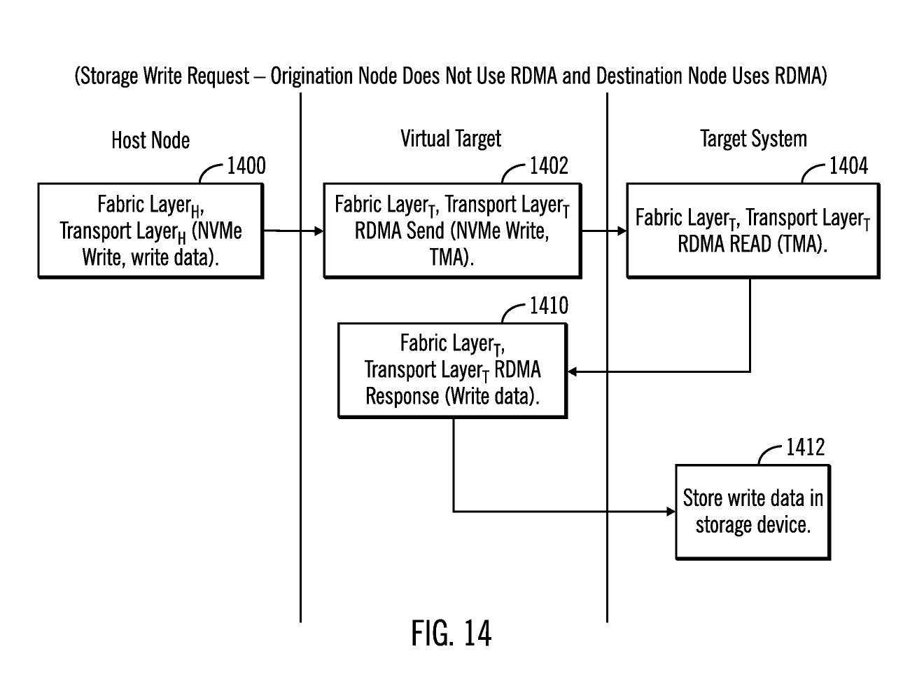

FIG. 14 illustrates an embodiment of the flow of a write request through a virtual target 108 when the origination node 102ᵢ does not use a direct memory access protocol and the destination (target) node 200ᵢ uses a direct memory access protocol according to the operations of FIG. 11. A host node 102ᵢ initiates operations by generating one or more packets 1400 including a fabric layer 402_{H} and transport layer 404_{H} encoded with the fabric and transport layers of the host node 102ᵢ, and an NVMe write 406 with the write data. Upon receiving this packet 1400, the virtual target 108 generates a packet 1402 including a fabric layer 402_{T} and transport layer 404_{T} for the target system 200ᵢ with an RDMA send of the NVMe write command with the transfer memory address 408 in the transfer memory 134. Upon receiving the packet 1402, the target system 200ᵢ generates a packet 1404 with a fabric layer 402_{T} and transport layer 404_{T} for the target system 200ᵢ and an RDMA READ to read the data at the transfer memory address 408 to write to the storage device. In response to the packet 1404, the virtual target manager 128 generates one or more packets 1410 including an RDMA response having the write data in the transfer memory address to provide so the target system 200ᵢ stores 1412 the write data in the storage device 300ᵢ

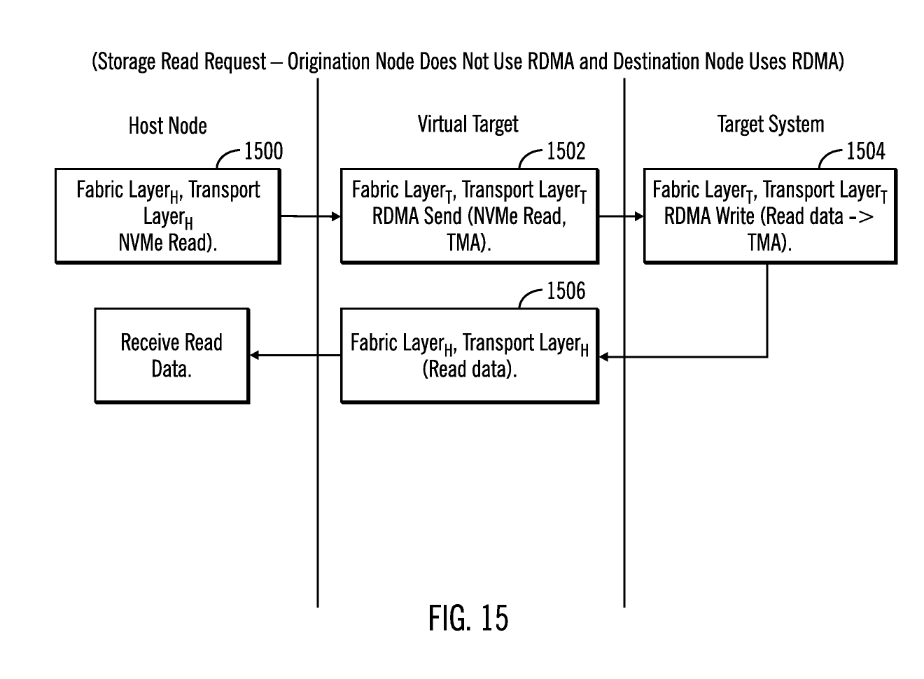

FIG. 15 illustrates an embodiment of the flow of a read request through a virtual target 108 when the origination node 102ᵢ does not use a direct memory access protocol and the destination (target) node 200ᵢ uses a direct memory access protocol according to the operations of FIG. 11. A host node 102ᵢ initiates operations by generating a packet 1500 including a fabric layer 402_{H} and transport layer 404_{H} encoded with the fabric and transport layers of the host node 102ᵢ, and an NVMe read 406. Upon receiving this packet 1500, the virtual target 108 generates a packet 1502 including a fabric layer 402_{T} and transport layer 404_{T} for the target system 200ᵢ with an RDMA send of the NVMe read command with the transfer memory address 408 in the transfer memory 134. Upon receiving the packet 1502, the target system 200ᵢ generates a packet 1504 with a fabric layer 402_{T} and transport layer 404_{T} for the target system 200ᵢ and an RDMA WRITE to write the requested read data to the target memory address. In response to the packet 1504, the virtual target manager 128 generates one or more packets 1506 including the received read data in the transfer memory address.

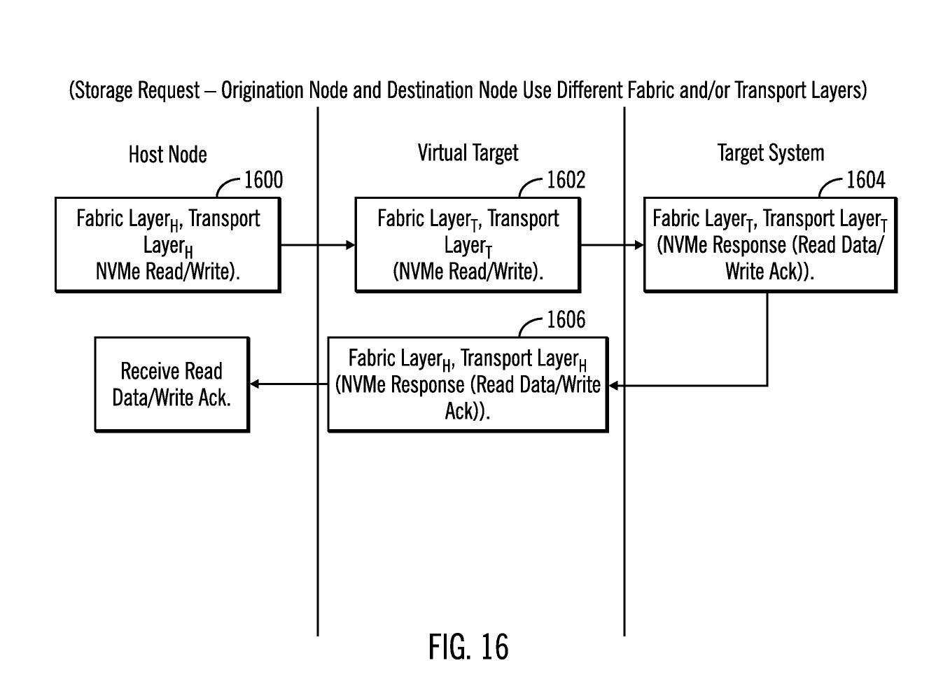

FIG. 16 illustrates an embodiment of the flow of a read request through a virtual target 108 when the origination node 102ᵢ and the destination (target) node 200ᵢ do not use a direct memory access protocol, but may use different fabric and/or transport protocols, according to the operations of FIG. 19. A host node 102ᵢ initiates operations by generating a packet 1600 including a fabric layer 402_{H} and transport layer 404_{H} encoded with the fabric and transport layers of the host node 102ᵢ, and an NVMe read/write request 406, or other type of request. In the flow of FIG. 16 there may be no host memory address 408. Upon receiving this packet 1600, the virtual target 108 generates a packet 1602 including a fabric layer 402_{T} and transport layer 404_{T} for the target system 200ᵢ, which may be encoded with a different fabric and/or transport protocol than used at the destination node 200ᵢ and the NVMe request. Upon receiving the packet 1602, the target system 200ᵢ generates a packet 1604 with a fabric layer 402_{T} and transport layer 404_{T} encoded in the fabric and transport protocol used at the target system 200ᵢ and a response to the NVMe storage request 406, which may comprise requested read data or a write complete acknowledgment. In response to the packet 1604, the virtual target manager 128 generates one or more packets 1606 including a fabric layer 402_{H} and transport layer 404_{H} encoded with the fabric and transport layers of the host node 102ᵢ, and including the response to the NVMe request.

The described operations of the processing components, such as components in the host node 102ᵢ, including 112, 114, 116, 118, in the virtual target 108, including 122, 124, 126, 114_{VT}, 128, 130, 132, in the target system 200ᵢ, including 202, 206, 208, 212, 214, 600, and in the storage device 300ᵢ, including 302, 304, and other components, may be implemented as a method, apparatus, device, computer product comprising a computer readable storage medium using standard programming and/or engineering techniques to produce software, firmware, hardware, or any combination thereof. The described operations may be implemented as code or logic maintained in a “computer readable storage medium”. The term “code” as used herein refers to software program code, hardware logic, firmware, microcode, etc. The computer readable storage medium, as that term is used herein, includes a tangible element, including at least one of electronic circuitry, storage materials, inorganic materials, organic materials, biological materials, a casing, a housing, a coating, and hardware. A computer readable storage medium may comprise, but is not limited to, a magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), Solid State Devices (SSD), computer encoded and readable punch cards, etc. A computer readable storage medium may also include any memory device that comprises non-volatile memory. In one embodiment, the memory device is a block addressable memory device, such as those based on NAND or NOR technologies. A memory device may also include future generation nonvolatile devices, such as a three dimensional cross-point memory device, or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The memory device may refer to the die itself and/or to a packaged memory product.

The computer readable storage medium may further comprise a hardware device implementing firmware, microcode, etc., such as in an integrated circuit chip, a programmable logic device, a Programmable Gate Array (PGA), field-programmable gate array (FPGA), Application Specific Integrated Circuit (ASIC), etc. Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The program code embedded on a computer readable storage medium may be transmitted as transmission signals from a transmitting station or computer to a receiving station or computer. A computer readable storage medium is not comprised solely of transmission signals, but includes physical and tangible components. Those skilled in the art will recognize that many modifications may be made to this configuration without departing from the scope of the present invention, and that the article of manufacture may comprise suitable information bearing medium known in the art.

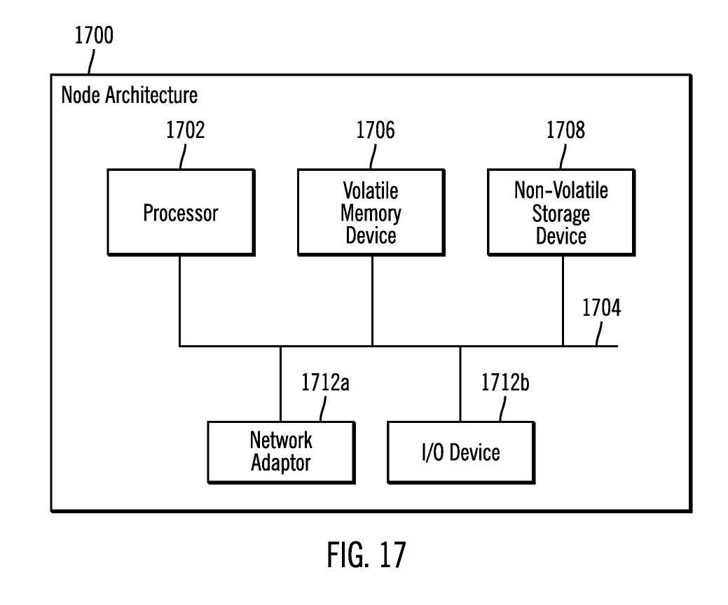

FIG. 17 illustrates an embodiment of a computer node architecture 1700, such as the components included in the host nodes 102₁, 102₂ . . . 102ₙ, the virtual target 108, and the target systems 200₁ . . . 200ₘ, including a processor 1702 that communicates over a bus 1704 with a volatile memory device 1706 in which programs, operands and parameters being executed are cached, and a non-volatile storage device 1704, such as target system memory 136. The bus 1704 may comprise multiple buses. Further, the bus 1704 may comprise a multi-agent bus or not be a multi-agent bus, and instead provide point-to-point connections according to PCIe architecture. The processor 1702 may also communicate with Input/output (I/O) devices 1712a, 1712b, which may comprise input devices, display devices, graphics cards, ports, network interfaces, etc. The network adaptor 1712a may comprise the physical interfaces 110₁, 110₂ . . . 110ₘ₊ₙ. For the host nodes 102₁, 102₂ . . . 102ₙ and the virtual target 108, the virtual storage resources may also appear on the bus 1704 as bus components.

In certain embodiments, the computer node architecture 1700 may comprise a personal computer, server, mobile device or embedded compute device. In a silicon-on-chip (SOC) implementation, the architecture 1700 may be implemented in an integrated circuit die. In certain implementations, the architecture 1700 may not include a PCIe bus to connect to NVMe storage devices, and instead include a network adaptor to connect to a fabric or network and send communications using the NVMe interface to communicate with the target systems 200₁ . . . 200ₘ to access underlying storage devices 300₁ . . . 300ₘ.

The reference characters used herein, such as i, m, n, and t are used to denote a variable number of instances of an element, which may represent the same or different values, and may represent the same or different value when used with different or the same elements in different described instances.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

### EXAMPLES

Example 1 is a computer program product including a computer readable storage media deployed and in communication with nodes over a network, wherein the computer readable storage media includes program code executed by at least one processor to: receive an origination package from an originating node at a first physical interface over a first network to a destination node having a storage device, wherein the origination package includes a first fabric layer encoded according to a first fabric protocol for transport through the first network, a first transport layer encoded according to a first transport protocol including a storage Input/Output (I/O) request directed to the storage device at the destination node in a logical device interface protocol; determine a transfer memory address in a transfer memory to use to transfer data for the storage I/O request; determine a second physical interface used to communicate to the destination node; encode at least one destination packet with a second fabric layer and a second protocol layer, wherein the second fabric layer is encoded according to the first fabric protocol for communication over the first network or a second fabric protocol for communication over a second network depending on whether the destination node communicates using the first fabric protocol or the second fabric protocol, respectively, and wherein a second transport layer is encoded according to the first transport protocol or a second transport protocol depending on whether the destination node communicates using the first transport protocol or the second transport protocol, respectively; and send the at least one destination packet to the second physical interface to transit to the destination node to perform the storage I/O request with respect to the storage device.

In Example 2, the subject matter of examples 1 and 3-10 can optionally include that the storage I/O request comprises a storage read request to read data in the storage device at the destination node, wherein the origination package includes a host memory address to which to return the read data, wherein the origination node uses a direct memory access protocol and the destination node does not use a direct memory access protocol, wherein the program code is further executed to: associate the host memory address with the determined transfer memory address; in response to receiving read data from the storage device in response to sending the at least one destination packet, store the read data at the transfer memory address; and send to the origination node a direct memory access write request to write data at the transfer memory address to the host memory address at the origination node.

In Example 3, the subject matter of examples 1, 2, and 4-10 can optionally include that the storage I/O request comprises a storage write request to write data in a host memory address to the storage device at the destination node, wherein the origination node uses a direct memory access protocol and the destination node does not use a direct memory access protocol, wherein the program code is further executed to: associate the host memory address with the determined transfer memory address; send a direct memory access read request to read the data at the host memory address to the origination node; and in response to receiving read data at the host memory address from the origination node, store the read data in the transfer memory address associated with the host memory address, wherein the at least one destination packet includes the read data in the transfer memory address for the storage write request.

In Example 4, the subject matter of examples 1-3 and 5-10 can optionally include that the storage I/O request comprises a storage read request to read data at the storage device at the destination node. wherein the destination node uses a direct memory access protocol and the origination node does not use a direct memory access protocol, wherein the at least one destination packet comprises one packet including a direct memory access send request for the storage read request with the transfer memory address, wherein the program code is further executed to: in response to sending the one packet including the direct memory access send request, receive from the destination node a direct memory access write request to the transfer memory address with the read data for the storage read request; and store the read data from the direct memory access write request in the transfer memory address to return to the origination node.

In Example 5, the subject matter of examples 1-4 and 6-10 can optionally include that the program code is further to: send at least one packet to the origination node including the read data in the transfer memory address conforming to the first fabric protocol and first transport layer.

In Example 6, the subject matter of examples 1-5 and 7-10 can optionally include the storage I/O request comprises a storage write request to write data at the storage device at the destination node. wherein the destination node uses a direct memory access protocol and the origination node does not use a direct memory access protocol, wherein the at least one destination packet comprises one packet including a direct memory access send request for the storage write request with the transfer memory address, wherein the program code is further executed to: store write data for the storage write request in the transfer memory address, wherein the at least one destination packet comprises a first destination packet including a direct memory access send request to send the storage write request with the transfer memory address to the destination node; in response to the first destination packet, receiving from the destination node a second destination packet including a direct memory access read request to the transfer memory address; and send to the destination node, a third destination packet including a direct memory access response with the data at the transfer memory address.

In Example 7, the subject matter of examples 1-6 and 8-10 can optionally include that the program code is further executed to: determine whether the first transport layer includes a send commend to send the storage I/O request with a host memory address at the originating node; and associate the transfer memory address and the host memory address in an address mapping, wherein the at least one destination packet comprises one destination packet, and wherein the second transport layer in the one destination packet includes the send command with the storage I/O request and the transfer memory address.

In Example 8, the subject matter of examples 1-7 and 9-10 can optionally include that the storage I/O request comprises a storage read request to read data at the storage device at the destination node, wherein the destination node and the origination node use a direct memory access protocol, wherein the origination package includes a host memory address in the origination node to which to return the read data, wherein the at least one destination packet comprises one destination packet including a direct memory access send request for the storage read request with the transfer memory address, wherein the program code is further executed to: associate the host memory address and the transfer memory address; in response to sending the destination packet including the direct memory access send request, receive from the destination node at least one destination response packet with a first write in the direct memory access protocol to write the read data to the transfer memory address; store the read data from the at least one destination response packet in the transfer memory address; and send to the origination node at least one origination response packet including a second write in the direct memory access protocol to write the read data to the host memory address.

In Example 9, the subject matter of examples 1-8 and 10 can optionally include that the storage I/O request comprises a storage write request to write data to the storage device at the destination node, wherein the destination node and the origination node use a direct memory access protocol, wherein the origination package includes a host memory address in the origination node having the write data, wherein the at least one destination packet comprises one destination packet including a direct memory access send request for the storage write request with the transfer memory address, wherein the program code is further executed to: associate the host memory address and the transfer memory address; in response to the destination packet, receiving a destination response packet including a direct memory access read request to read the data at the transfer memory address; in response to the destination response packet, sending an origination response packet including a direct memory access read request to read data at the host memory address; and in response to the origination response packet, send a direct memory access response to the destination node including the read data from the transfer memory address.

In Example 10, the subject matter of examples 1-9 can optionally include that the logical device interface protocol comprises a Non-Volatile Memory Express (NVMe) protocol, wherein the first and second transport protocols comprises one of Transport Control Protocol/Internet Protocol (TCP/IP), User Datagram Protocol (UDP), and Remote Direct Memory Access (RDMA) over Converged Ethernet (RoCE) when RDMA is used, and wherein the first and second fabric layer protocols comprises one of Ethernet, InfiniBand, Fibre Channel, and iWARP when RDMA is used.

Example 11 is a system in communication with nodes over a network, comprising: a processor; and a computer readable storage media including program code executed by the processor to: receive an origination package from an originating node at a first physical interface over a first network to a destination node having a storage device, wherein the origination package includes a first fabric layer encoded according to a first fabric protocol for transport through the first network, a first transport layer encoded according to a first transport protocol including a storage Input/Output (I/O) request directed to the storage device at the destination node in a logical device interface protocol; determine a transfer memory address in a transfer memory to use to transfer data for the storage I/O request; determine a second physical interface used to communicate to the destination node; encode at least one destination packet with a second fabric layer and a second protocol layer, wherein the second fabric layer is encoded according to the first fabric protocol for communication over the first network or a second fabric protocol for communication over a second network depending on whether the destination node communicates using the first fabric protocol or the second fabric protocol, respectively, and wherein a second transport layer is encoded according to the first transport protocol or a second transport protocol depending on whether the destination node communicates using the first transport protocol or the second transport protocol, respectively; and send the at least one destination packet to the second physical interface to transit to the destination node to perform the storage I/O request with respect to the storage device.

In Example 12, the subject matter of examples 11 and 13-18 can optionally include that the storage I/O request comprises a storage read request to read data in the storage device at the destination node, wherein the origination package includes a host memory address to which to return the read data, wherein the origination node uses a direct memory access protocol and the destination node does not use a direct memory access protocol, wherein the program code is further executed to: associate the host memory address with the determined transfer memory address; in response to receiving read data from the storage device in response to sending the at least one destination packet, store the read data at the transfer memory address; and send to the origination node a direct memory access write request to write data at the transfer memory address to the host memory address at the origination node.

In Example 13, the subject matter of examples 11, 12 and 14-18 can optionally include that the storage I/O request comprises a storage write request to write data in a host memory address to the storage device at the destination node, wherein the origination node uses a direct memory access protocol and the destination node does not use a direct memory access protocol, wherein the program code is further executed to: associate the host memory address with the determined transfer memory address; send a direct memory access read request to read the data at the host memory address to the origination node; and in response to receiving read data at the host memory address from the origination node, store the read data in the transfer memory address associated with the host memory address, wherein the at least one destination packet includes the read data in the transfer memory address for the storage write request.

In Example 14, the subject matter of examples 11-13 and 15-18 can optionally include that the storage I/O request comprises a storage read request to read data at the storage device at the destination node. wherein the destination node uses a direct memory access protocol and the origination node does not use a direct memory access protocol, wherein the at least one destination packet comprises one packet including a direct memory access send request for the storage read request with the transfer memory address, wherein the program code is further executed to: in response to sending the one packet including the direct memory access send request, receive from the destination node a direct memory access write request to the transfer memory address with the read data for the storage read request; and store the read data from the direct memory access write request in the transfer memory address to return to the origination node.

In Example 15, the subject matter of examples 11-14 and 16-18 can optionally include that the storage I/O request comprises a storage write request to write data at the storage device at the destination node. wherein the destination node uses a direct memory access protocol and the origination node does not use a direct memory access protocol, wherein the at least one destination packet comprises one packet including a direct memory access send request for the storage write request with the transfer memory address, wherein the program code is further executed to: store write data for the storage write request in the transfer memory address, wherein the at least one destination packet comprises a first destination packet including a direct memory access send request to send the storage write request with the transfer memory address to the destination node; in response to the first destination packet, receiving from the destination node a second destination packet including a direct memory access read request to the transfer memory address; and send to the destination node, a third destination packet including a direct memory access response with the data at the transfer memory address.

In Example 16, the subject matter of examples 11-15 and 17-18 can optionally include that the program code is further executed to: determine whether the first transport layer includes a send commend to send the storage I/O request with a host memory address at the originating node; and associate the transfer memory address and the host memory address in an address mapping, wherein the at least one destination packet comprises one destination packet, and wherein the second transport layer in the one destination packet includes the send command with the storage I/O request and the transfer memory address.

In Example 17, the subject matter of examples 11-16 and 18 can optionally include that the storage I/O request comprises a storage read request to read data at the storage device at the destination node, wherein the destination node and the origination node use a direct memory access protocol, wherein the origination package includes a host memory address in the origination node to which to return the read data, wherein the at least one destination packet comprises one destination packet including a direct memory access send request for the storage read request with the transfer memory address, wherein the program code is further executed to: associate the host memory address and the transfer memory address; in response to sending the destination packet including the direct memory access send request, receive from the destination node at least one destination response packet with a first write in the direct memory access protocol to write the read data to the transfer memory address; store the read data from the at least one destination response packet in the transfer memory address; and send to the origination node at least one origination response packet including a second write in the direct memory access protocol to write the read data to the host memory address.

In Example 18, the subject matter of examples 11-17 can optionally include that the storage I/O request comprises a storage write request to write data to the storage device at the destination node, wherein the destination node and the origination node use a direct memory access protocol, wherein the origination package includes a host memory address in the origination node having the write data, wherein the at least one destination packet comprises one destination packet including a direct memory access send request for the storage write request with the transfer memory address, wherein the program code is further executed to: associate the host memory address and the transfer memory address; in response to the destination packet, receiving a destination response packet including a direct memory access read request to read the data at the transfer memory address; in response to the destination response packet, sending an origination response packet including a direct memory access read request to read data at the host memory address; and in response to the origination response packet, send a direct memory access response to the destination node including the read data from the transfer memory address.

Example 19 is a method for communicating with nodes over a network, comprising: receiving an origination package from an originating node at a first physical interface over a first network to a destination node having a storage device, wherein the origination package includes a first fabric layer encoded according to a first fabric protocol for transport through the first network, a first transport layer encoded according to a first transport protocol including a storage Input/Output (I/O) request directed to the storage device at the destination node in a logical device interface protocol; determining a transfer memory address in a transfer memory to use to transfer data for the storage I/O request; determining a second physical interface used to communicate to the destination node; encoding at least one destination packet with a second fabric layer and a second protocol layer, wherein the second fabric layer is encoded according to the first fabric protocol for communication over the first network or a second fabric protocol for communication over a second network depending on whether the destination node communicates using the first fabric protocol or the second fabric protocol, respectively, and wherein a second transport layer is encoded according to the first transport protocol or a second transport protocol depending on whether the destination node communicates using the first transport protocol or the second transport protocol, respectively; and sending the at least one destination packet to the second physical interface to transit to the destination node to perform the storage I/O request with respect to the storage device.

In Example 20, the subject matter of examples 19 and 21-25 can optionally include that the storage I/O request comprises a storage read request to read data in the storage device at the destination node, wherein the origination package includes a host memory address to which to return the read data, wherein the origination node uses a direct memory access protocol and the destination node does not use a direct memory access protocol, further comprising: associating the host memory address with the determined transfer memory address; in response to receiving read data from the storage device in response to sending the at least one destination packet, storing the read data at the transfer memory address; and sending to the origination node a direct memory access write request to write data at the transfer memory address to the host memory address at the origination node.

In Example 21, the subject matter of examples 19, 20 and 22-25 can optionally include that the storage I/O request comprises a storage write request to write data in a host memory address to the storage device at the destination node, wherein the origination node uses a direct memory access protocol and the destination node does not use a direct memory access protocol, further comprising: associating the host memory address with the determined transfer memory address; sending a direct memory access read request to read the data at the host memory address to the origination node; and in response to receiving read data at the host memory address from the origination node, storing the read data in the transfer memory address associated with the host memory address, wherein the at least one destination packet includes the read data in the transfer memory address for the storage write request.

In Example 22, the subject matter of examples 19-21 and 23-25 can optionally include that the storage I/O request comprises a storage read request to read data at the storage device at the destination node. wherein the destination node uses a direct memory access protocol and the origination node does not use a direct memory access protocol, wherein the at least one destination packet comprises one packet including a direct memory access send request for the storage read request with the transfer memory address, further comprising: in response to sending the one packet including the direct memory access send request, receiving from the destination node a direct memory access write request to the transfer memory address with the read data for the storage read request; and storing the read data from the direct memory access write request in the transfer memory address to return to the origination node.

In Example 23, the subject matter of examples 19-22 and 24-25 can optionally include that the storage I/O request comprises a storage write request to write data at the storage device at the destination node. wherein the destination node uses a direct memory access protocol and the origination node does not use a direct memory access protocol, wherein the at least one destination packet comprises one packet including a direct memory access send request for the storage write request with the transfer memory address, further comprising: storing write data for the storage write request in the transfer memory address, wherein the at least one destination packet comprises a first destination packet including a direct memory access send request to send the storage write request with the transfer memory address to the destination node; in response to the first destination packet, receiving from the destination node a second destination packet including a direct memory access read request to the transfer memory address; and sending to the destination node, a third destination packet including a direct memory access response with the data at the transfer memory address.

In Example 24, the subject matter of examples 19-23 and 25 can optionally include determining whether the first transport layer includes a send commend to send the storage I/O request with a host memory address at the originating node; and associating the transfer memory address and the host memory address in an address mapping, wherein the at least one destination packet comprises one destination packet, and wherein the second transport layer in the one destination packet includes the send command with the storage I/O request and the transfer memory address.

In Example 25, the subject matter of examples 19-24 can optionally include that the storage I/O request comprises a storage read request to read data at the storage device at the destination node, wherein the destination node and the origination node use a direct memory access protocol, wherein the origination package includes a host memory address in the origination node to which to return the read data, wherein the at least one destination packet comprises one destination packet including a direct memory access send request for the storage read request with the transfer memory address, further comprising: associating the host memory address and the transfer memory address; in response to sending the destination packet including the direct memory access send request, receiving from the destination node at least one destination response packet with a first write in the direct memory access protocol to write the read data to the transfer memory address; storing the read data from the at least one destination response packet in the transfer memory address; and sending to the origination node at least one origination response packet including a second write in the direct memory access protocol to write the read data to the host memory address.

Example 26 is an apparatus for communicating with nodes over a network, comprising: means for receiving an origination package from an originating node at a first physical interface over a first network to a destination node having a storage device, wherein the origination package includes a first fabric layer encoded according to a first fabric protocol for transport through the first network, a first transport layer encoded according to a first transport protocol including a storage Input/Output (I/O) request directed to the storage device at the destination node in a logical device interface protocol; means for determining a transfer memory address in a transfer memory to use to transfer data for the storage I/O request; means for determining a second physical interface used to communicate to the destination node; means for encoding at least one destination packet with a second fabric layer and a second protocol layer, wherein the second fabric layer is encoded according to the first fabric protocol for communication over the first network or a second fabric protocol for communication over a second network depending on whether the destination node communicates using the first fabric protocol or the second fabric protocol, respectively, and wherein a second transport layer is encoded according to the first transport protocol or a second transport protocol depending on whether the destination node communicates using the first transport protocol or the second transport protocol, respectively; and means for sending the at least one destination packet to the second physical interface to transit to the destination node to perform the storage I/O request with respect to the storage device.

Example 27 is an apparatus comprising means to perform a method as claimed in any preceding claim.

What is claimed:

1. A computer program product including a computer readable storage media deployed and in communication with nodes over a network, wherein the computer readable storage media includes program code executed by at least one processor to:
receive an origination package from an originating node at a first physical interface over a first network to a destination node having a storage device, wherein the origination package includes a first fabric layer encoded according to a first fabric protocol for transport through the first network, a first transport layer encoded according to a first transport protocol including a storage Input/Output (I/O) request directed to the storage device at the destination node in a logical device interface protocol;
determine a transfer memory address in a transfer memory to use to transfer data for the storage I/O request;
determine a second physical interface used to communicate to the destination node;
encode at least one destination packet with a second fabric layer and a second protocol layer, wherein the second fabric layer is encoded according to the first fabric protocol for communication over the first network or a second fabric protocol for communication over a second network depending on whether the destination node communicates using the first fabric protocol or the second fabric protocol, respectively, and wherein a second transport layer is encoded according to the first transport protocol or a second transport protocol depending on whether the destination node communicates using the first transport protocol or the second transport protocol, respectively; and
send the at least one destination packet to the second physical interface to transit to the destination node to perform the storage I/O request with respect to the storage device.

2. The computer program product of claim 1, wherein the storage I/O request comprises a storage read request to read data in the storage device at the destination node, wherein the origination package includes a host memory address to which to return the read data, wherein the origination node uses a direct memory access protocol and the destination node does not use a direct memory access protocol, wherein the program code is further executed to:
associate the host memory address with the determined transfer memory address;
in response to receiving read data from the storage device in response to sending the at least one destination packet, store the read data at the transfer memory address; and
send to the origination node a direct memory access write request to write data at the transfer memory address to the host memory address at the origination node.

3. The computer program product of claim 1, wherein the storage I/O request comprises a storage write request to write data in a host memory address to the storage device at the destination node, wherein the origination node uses a direct memory access protocol and the destination node does not use a direct memory access protocol, wherein the program code is further executed to:
associate the host memory address with the determined transfer memory address;
send a direct memory access read request to read the data at the host memory address to the origination node; and
in response to receiving read data at the host memory address from the origination node, store the read data in the transfer memory address associated with the host memory address, wherein the at least one destination packet includes the read data in the transfer memory address for the storage write request.

4. The computer program product of claim 1, wherein the storage I/O request comprises a storage read request to read data at the storage device at the destination node. wherein the destination node uses a direct memory access protocol and the origination node does not use a direct memory access protocol, wherein the at least one destination packet comprises one packet including a direct memory access send request for the storage read request with the transfer memory address, wherein the program code is further executed to:
in response to sending the one packet including the direct memory access send request, receive from the destination node a direct memory access write request to the transfer memory address with the read data for the storage read request; and
store the read data from the direct memory access write request in the transfer memory address to return to the origination node.

5. The computer program product of claim 4, wherein the program code is further to:
send at least one packet to the origination node including the read data in the transfer memory address conforming to the first fabric protocol and first transport layer.

6. The computer program product of claim 1, wherein the storage I/O request comprises a storage write request to write data at the storage device at the destination node. wherein the destination node uses a direct memory access protocol and the origination node does not use a direct memory access protocol, wherein the at least one destination packet comprises one packet including a direct memory access send request for the storage write request with the transfer memory address, wherein the program code is further executed to:
store write data for the storage write request in the transfer memory address, wherein the at least one destination packet comprises a first destination packet including a direct memory access send request to send the storage write request with the transfer memory address to the destination node;
in response to the first destination packet, receiving from the destination node a second destination packet including a direct memory access read request to the transfer memory address; and
send to the destination node, a third destination packet including a direct memory access response with the data at the transfer memory address.

7. The computer program product of claim 6, wherein the program code is further executed to:
determine whether the first transport layer includes a send commend to send the storage I/O request with a host memory address at the originating node; and
associate the transfer memory address and the host memory address in an address mapping, wherein the at least one destination packet comprises one destination packet, and wherein the second transport layer in the one destination packet includes the send command with the storage I/O request and the transfer memory address.

8. The computer program product of claim 1, wherein the storage I/O request comprises a storage read request to read data at the storage device at the destination node, wherein the destination node and the origination node use a direct memory access protocol, wherein the origination package includes a host memory address in the origination node to which to return the read data, wherein the at least one destination packet comprises one destination packet including a direct memory access send request for the storage read request with the transfer memory address, wherein the program code is further executed to:
associate the host memory address and the transfer memory address;
in response to sending the destination packet including the direct memory access send request, receive from the destination node at least one destination response packet with a first write in the direct memory access protocol to write the read data to the transfer memory address;
store the read data from the at least one destination response packet in the transfer memory address; and
send to the origination node at least one origination response packet including a second write in the direct memory access protocol to write the read data to the host memory address.

9. The computer program product of claim 1, wherein the storage I/O request comprises a storage write request to write data to the storage device at the destination node, wherein the destination node and the origination node use a direct memory access protocol, wherein the origination package includes a host memory address in the origination node having the write data, wherein the at least one destination packet comprises one destination packet including a direct memory access send request for the storage write request with the transfer memory address, wherein the program code is further executed to:
associate the host memory address and the transfer memory address;
in response to the destination packet, receiving a destination response packet including a direct memory access read request to read the data at the transfer memory address;
in response to the destination response packet, sending an origination response packet including a direct memory access read request to read data at the host memory address; and
in response to the origination response packet, send a direct memory access response to the destination node including the read data from the transfer memory address.

10. The computer program product of claim 1, wherein the logical device interface protocol comprises a Non-Volatile Memory Express (NVMe) protocol, wherein the first and second transport protocols comprises one of Transport Control Protocol/Internet Protocol (TCP/IP), User Datagram Protocol (UDP), and Remote Direct Memory Access (RDMA) over Converged Ethernet (RoCE) when RDMA is used, and wherein the first and second fabric layer protocols comprises one of Ethernet, InfiniBand, Fibre Channel, and iWARP when RDMA is used.

11. A system in communication with nodes over a network, comprising:
a processor; and
a computer readable storage media including program code executed by the processor to:
receive an origination package from an originating node at a first physical interface over a first network to a destination node having a storage device, wherein the origination package includes a first fabric layer encoded according to a first fabric protocol for transport through the first network, a first transport layer encoded according to a first transport protocol including a storage Input/Output (I/O) request directed to the storage device at the destination node in a logical device interface protocol;
determine a transfer memory address in a transfer memory to use to transfer data for the storage I/O request;
determine a second physical interface used to communicate to the destination node;
encode at least one destination packet with a second fabric layer and a second protocol layer, wherein the second fabric layer is encoded according to the first fabric protocol for communication over the first network or a second fabric protocol for communication over a second network depending on whether the destination node communicates using the first fabric protocol or the second fabric protocol, respectively, and wherein a second transport layer is encoded according to the first transport protocol or a second transport protocol depending on whether the destination node communicates using the first transport protocol or the second transport protocol, respectively; and
send the at least one destination packet to the second physical interface to transit to the destination node to perform the storage I/O request with respect to the storage device.

12. The system of claim 11, wherein the storage I/O request comprises a storage read request to read data in the storage device at the destination node, wherein the origination package includes a host memory address to which to return the read data, wherein the origination node uses a direct memory access protocol and the destination node does not use a direct memory access protocol, wherein the program code is further executed to:
associate the host memory address with the determined transfer memory address;
in response to receiving read data from the storage device in response to sending the at least one destination packet, store the read data at the transfer memory address; and
send to the origination node a direct memory access write request to write data at the transfer memory address to the host memory address at the origination node.

13. The system of claim 11, wherein the storage I/O request comprises a storage write request to write data in a host memory address to the storage device at the destination node, wherein the origination node uses a direct memory access protocol and the destination node does not use a direct memory access protocol, wherein the program code is further executed to:
associate the host memory address with the determined transfer memory address;
send a direct memory access read request to read the data at the host memory address to the origination node; and
in response to receiving read data at the host memory address from the origination node, store the read data in the transfer memory address associated with the host memory address, wherein the at least one destination packet includes the read data in the transfer memory address for the storage write request.

14. The system of claim 11, wherein the storage I/O request comprises a storage read request to read data at the storage device at the destination node. wherein the destination node uses a direct memory access protocol and the origination node does not use a direct memory access protocol, wherein the at least one destination packet comprises one packet including a direct memory access send request for the storage read request with the transfer memory address, wherein the program code is further executed to:
in response to sending the one packet including the direct memory access send request, receive from the destination node a direct memory access write request to the transfer memory address with the read data for the storage read request; and
store the read data from the direct memory access write request in the transfer memory address to return to the origination node.

15. The system of claim 11, wherein the storage I/O request comprises a storage write request to write data at the storage device at the destination node. wherein the destination node uses a direct memory access protocol and the origination node does not use a direct memory access protocol, wherein the at least one destination packet comprises one packet including a direct memory access send request for the storage write request with the transfer memory address, wherein the program code is further executed to:
store write data for the storage write request in the transfer memory address, wherein the at least one destination packet comprises a first destination packet including a direct memory access send request to send the storage write request with the transfer memory address to the destination node;
in response to the first destination packet, receiving from the destination node a second destination packet including a direct memory access read request to the transfer memory address; and
send to the destination node, a third destination packet including a direct memory access response with the data at the transfer memory address.

16. The system of claim 15, wherein the program code is further executed to:
determine whether the first transport layer includes a send commend to send the storage I/O request with a host memory address at the originating node; and
associate the transfer memory address and the host memory address in an address mapping, wherein the at least one destination packet comprises one destination packet, and wherein the second transport layer in the one destination packet includes the send command with the storage I/O request and the transfer memory address.

17. The system of claim 11, wherein the storage I/O request comprises a storage read request to read data at the storage device at the destination node, wherein the destination node and the origination node use a direct memory access protocol, wherein the origination package includes a host memory address in the origination node to which to return the read data, wherein the at least one destination packet comprises one destination packet including a direct memory access send request for the storage read request with the transfer memory address, wherein the program code is further executed to:
associate the host memory address and the transfer memory address;
in response to sending the destination packet including the direct memory access send request, receive from the destination node at least one destination response packet with a first write in the direct memory access protocol to write the read data to the transfer memory address;
store the read data from the at least one destination response packet in the transfer memory address; and
send to the origination node at least one origination response packet including a second write in the direct memory access protocol to write the read data to the host memory address.

18. The system of claim 11, wherein the storage I/O request comprises a storage write request to write data to the storage device at the destination node, wherein the destination node and the origination node use a direct memory access protocol, wherein the origination package includes a host memory address in the origination node having the write data, wherein the at least one destination packet comprises one destination packet including a direct memory access send request for the storage write request with the transfer memory address, wherein the program code is further executed to:
associate the host memory address and the transfer memory address;
in response to the destination packet, receiving a destination response packet including a direct memory access read request to read the data at the transfer memory address;
in response to the destination response packet, sending an origination response packet including a direct memory access read request to read data at the host memory address; and
in response to the origination response packet, send a direct memory access response to the destination node including the read data from the transfer memory address.

19. A method for communicating with nodes over a network, comprising:
receiving an origination package from an originating node at a first physical interface over a first network to a destination node having a storage device, wherein the origination package includes a first fabric layer encoded according to a first fabric protocol for transport through the first network, a first transport layer encoded according to a first transport protocol including a storage Input/Output (I/O) request directed to the storage device at the destination node in a logical device interface protocol;
determining a transfer memory address in a transfer memory to use to transfer data for the storage I/O request;
determining a second physical interface used to communicate to the destination node;
encoding at least one destination packet with a second fabric layer and a second protocol layer, wherein the second fabric layer is encoded according to the first fabric protocol for communication over the first network or a second fabric protocol for communication over a second network depending on whether the destination node communicates using the first fabric protocol or the second fabric protocol, respectively, and wherein a second transport layer is encoded according to the first transport protocol or a second transport protocol depending on whether the destination node communicates using the first transport protocol or the second transport protocol, respectively; and
sending the at least one destination packet to the second physical interface to transit to the destination node to perform the storage I/O request with respect to the storage device.

20. The method of claim 19, wherein the storage I/O request comprises a storage read request to read data in the storage device at the destination node, wherein the origination package includes a host memory address to which to return the read data, wherein the origination node uses a direct memory access protocol and the destination node does not use a direct memory access protocol, further comprising:
associating the host memory address with the determined transfer memory address;
in response to receiving read data from the storage device in response to sending the at least one destination packet, storing the read data at the transfer memory address; and
sending to the origination node a direct memory access write request to write data at the transfer memory address to the host memory address at the origination node.

21. The method of claim 19, wherein the storage I/O request comprises a storage write request to write data in a host memory address to the storage device at the destination node, wherein the origination node uses a direct memory access protocol and the destination node does not use a direct memory access protocol, further comprising:
associating the host memory address with the determined transfer memory address;
sending a direct memory access read request to read the data at the host memory address to the origination node; and
in response to receiving read data at the host memory address from the origination node, storing the read data in the transfer memory address associated with the host memory address, wherein the at least one destination packet includes the read data in the transfer memory address for the storage write request.

22. The method of claim 19, wherein the storage I/O request comprises a storage read request to read data at the storage device at the destination node. wherein the destination node uses a direct memory access protocol and the origination node does not use a direct memory access protocol, wherein the at least one destination packet comprises one packet including a direct memory access send request for the storage read request with the transfer memory address, further comprising:
in response to sending the one packet including the direct memory access send request, receiving from the destination node a direct memory access write request to the transfer memory address with the read data for the storage read request; and
storing the read data from the direct memory access write request in the transfer memory address to return to the origination node.

23. The method of claim 19, wherein the storage I/O request comprises a storage write request to write data at the storage device at the destination node. wherein the destination node uses a direct memory access protocol and the origination node does not use a direct memory access protocol, wherein the at least one destination packet comprises one packet including a direct memory access send request for the storage write request with the transfer memory address, further comprising:
storing write data for the storage write request in the transfer memory address, wherein the at least one destination packet comprises a first destination packet including a direct memory access send request to send the storage write request with the transfer memory address to the destination node;
in response to the first destination packet, receiving from the destination node a second destination packet including a direct memory access read request to the transfer memory address; and
sending to the destination node, a third destination packet including a direct memory access response with the data at the transfer memory address.

24. The method of claim 23, further comprising:
determining whether the first transport layer includes a send commend to send the storage I/O request with a host memory address at the originating node; and
associating the transfer memory address and the host memory address in an address mapping, wherein the at least one destination packet comprises one destination packet, and wherein the second transport layer in the one destination packet includes the send command with the storage I/O request and the transfer memory address.

25. The method of claim 19, wherein the storage I/O request comprises a storage read request to read data at the storage device at the destination node, wherein the destination node and the origination node use a direct memory access protocol, wherein the origination package includes a host memory address in the origination node to which to return the read data, wherein the at least one destination packet comprises one destination packet including a direct memory access send request for the storage read request with the transfer memory address, further comprising:
associating the host memory address and the transfer memory address;
in response to sending the destination packet including the direct memory access send request, receiving from the destination node at least one destination response packet with a first write in the direct memory access protocol to write the read data to the transfer memory address;
storing the read data from the at least one destination response packet in the transfer memory address; and
sending to the origination node at least one origination response packet including a second write in the direct memory access protocol to write the read data to the host memory address.
